(19) United States
(12) Patent Application Publication
(10) Pub. No.: US 2012/0177848 A1
(43) Pub. Date: Jul. 12, 2012

(54) CELLULOSE ACYLATE FILM, POLARIZING PLATE, AND LIQUID CRYSTAL DISPLAY DEVICE

(75) Inventors: Kazuo KAMOHARA, Kanagawa (JP); Kengo ASAI, Kanagawa (JP)

(73) Assignee: FUJIFILM CORPORATION, Tokyo (JP)

(21) Appl. No.: 13/347,321

(22) Filed: Jan. 10, 2012

(30) Foreign Application Priority Data
Jan. 11, 2011 (JP) 2011-003501

(51) Int. Cl. C09K 19/00; C09D 101/02

(52) U.S. Cl. 428/1.31; 428/1.33; 106/168.01; 106/170.26

(57) ABSTRACT

A cellulose acylate film, having: a cellulose acylate mixture; and a plasticizer, wherein the cellulose acylate mixture contains: a cellulose acetate having a degree of substitution with acetyl group of 2.7 to 2.95; a cellulose acylate having a total degree of substitution with acyl group of 2.0 to 2.9 and a degree of substation with acyl group having 3 to 6 carbon atoms of 0.05 to 0.40, a mixing ratio of the cellulose acetate to the cellulose acylate is 90/10 to 40/60 by mass, the cellulose acylate mixture has a total degree of substitution with acyl group of 2.6 to 2.95, a degree of substitution with acetyl group of 2.2 to 2.9, and a degree of substitution with acyl group having 3 to 6 carbon atoms of 0.05 to 0.40, and an amount of the plasicizer is 30% to 60% by mass based on the cellulose acylate mixture.

### CROSS-REFERENCE TO RELATED APPLICATION(S)

The present application claims priority from Japanese Patent Application No. 2011-003501 filed on Jan. 11, 2011, the entire content of which is incorporated herein by reference.

### BACKGROUND

1. Field

The present invention relates to a cellulose acylate film, a polarizing plate, and a liquid crystal display device.

2. Description of the Related Art

Conventionally, cellulose acylate films have been used for photographic supports and various optical materials due to their excellent toughness and flame retardancy. In particular, recently, the cellulose acylate films have been frequently used as optical transparent films for liquid crystal display devices. Since cellulose acylate films have high optical transparency and high optical isotropy, the cellulose acylate films are excellent for use as optical materials for devices dealing with polarization, such as liquid crystal display devices, and thus the cellulose acylate films have hitherto been used as protective films of polarizers or optically-compensatory films capable of improving displays viewed from oblique directions (viewing-angle compensation).

Most of the optical films in which cellulose acylate is used are used with plasticizers added from the viewpoint of optical performances and mechanical properties. Plasticizers are generally added in an amount of around 10% to 20% by mass based on cellulose acylate (cotton).

However, for example, optical performances or mechanical properties required as optically-compensatory films of liquid crystal display devices and the like have been diversified, and thus various functionalities need to be performed by adding more amounts of plasticizers. In particular, cellulose acylate films, which do not have any bleed out (exudation) even under high temperature and high humidity environment and do not have any humidity dependence of optical properties, are required.

When the moist heat durability of or humidity dependence of optical properties of cellulose acylate are intended to be improved, a hydrophobicizing method may be used by increasing the degree of substitution with acetyl group to add more amounts of hydrophobic plasticizers. However, cellulose acetate itself is hydrophilic, and thus, if more than a certain amount of hydrophobic plasticizers are added, bleed-out occurs, resulting in whitening phenomena, when a film is formed or upon a continuous exposure to humidity or heat for a certain period of time (elapse of moist heat time). Therefore, it is impossible to add a required amount of plasticizers.

Japanese Patent Application Laid-Open No. 2003-105129 discloses a film that uses cellulose acylate of which the kind and degree of substitution with acyl group are controlled in a certain range.

Japanese Patent No. 3829902 discloses a film that uses cellulose acylate having high degree of acetyl substitution.

However, in cellulose acylate films described in the above patent documents, improvements in moist heat durability (suppression of bleed-out) and humidity dependence of optical properties may not be simultaneously achieved.

An object of the present invention is to provide a cellulose acylate film with a suppressed bleed-out even under high humidity and high temperature conditions and having low humidity dependence of optical properties.

### SUMMARY

The present inventors have intensively studied to solve the above-mentioned problem, and as a result, found that the problem may be solved by the following configuration.

(1) A cellulose acylate film, having: a cellulose acylate mixture; and a plasticizer, wherein the cellulose acylate mixture contains: a cellulose acetate (A) having a degree of substitution with acetyl group of 2.7 to 2.95; a cellulose acylate (B) having a total degree of substitution with acyl group of 2.0 to 2.9 and a degree of substation with acyl group having 3 to 6 carbon atoms of 0.05 to 0.40, a mixing ratio of the cellulose acetate (A) to the cellulose acylate (B) is 90/10 to 40/60 by mass, the cellulose acylate mixture has a total degree of substitution with acyl group of 2.6 to 2.95, a degree of substitution with acetyl group of 2.2 to 2.9, and a degree of substitution with acyl group having 3 to 6 carbon atoms of 0.05 to 0.40, and an amount of the plasicizer is 30% to 60% by mass based on the cellulose acylate mixture.
(2) The cellulose acylate film according to (1), wherein the plasticizer contains a mixture having: at least one of aromatic dicarboxylic acid and aliphatic dicarboxylic acid; and an aliphatic diol having an average carbon number of 2.0 to 3.0, and the plasticizer is a polycondensate ester of which both terminals are a hydroxyl group.
(3) The cellulose acylate film of (1), wherein the plasticizer contains a mixture having: at least one of aromatic dicarboxylic acid and aliphatic dicarboxylic acid; an aliphatic diol having an average carbon number of 2.0 to 3.0; and a monocarboxylic acid, the plasticizer is a polycondensate ester of which both terminals include a monocarboxylic acid ester derivative.
(4) The cellulose acylate film according to (2), wherein the plasticizer contains a nitrogen containing aromatic compound.
(5) The cellulose acylate film according to (3), wherein the plasticizer contains a nitrogen containing aromatic compound.
(6) The cellulose acylate film according to (4), wherein the nitrogen containing aromatic compound is contained in an amount of 20% by mass or less based on the cellulose acylate mixture.
(7) The cellulose acylate film according to (5), wherein the nitrogen containing aromatic compound is contained in an amount of 20% by mass or less based on the cellulose acylate mixture.
(8) The cellulose acylate film of according to (1), wherein the acyl group having 3 to 6 carbon atoms is at least one selected from a propionyl group and a butyryl group.
(9) The cellulose acylate film of according to (1), wherein the mixing ratio of the cellulose acetate (A) to the cellulose acylate (B) is 90/10 to 50/50 by mass.
(10) A polarizing plate, having: a polarizing film; and at least one protective film, wherein the at least one protective film is the cellulose acylate film according to (1).
(11) A liquid crystal display device having the cellulose acylate film according to (1).
(12) A liquid crystal display device having the polarizing plate according to (10).

According to the present invention, a cellulose acylate film with a suppressed bleed-out even under high humidity and high temperature conditions and having low humidity dependence of optical properties, can be provided.

The present invention relates to a cellulose acylate film including a cellulose acylate which is obtained by mixing the following cellulose acetate (A) and the following cellulose acylate (B) in the cellulose acetate (A)/cellulose acylate (B) of 90/10 to 40/60 in mass ratio, and which has a total degree of substitution with acyl group of 2.6 to 2.95, and a degree of substitution with acetyl group of 2.2 to 2.9 and a degree of substitution with acyl group having 3 to 6 carbon atoms of 0.05 to 0.40; and 30% to 65% by mass of a plasticizer based on the cellulose acetate.

Cellulose acetate (A): a cellulose acetate having a degree of substitution with acetyl group of 2.7 to 2.95

Cellulose acylate (B): a cellulose acylate having a total degree of substitution with acyl group of 2.0 to 2.9 and a degree of substitution with acyl group having 3 to 6 carbon atoms of 0.3 to 1.9

### DETAILED DESCRIPTION OF THE INVENTION

Hereinafter, the present invention will be described in more detail.

[Cellulose Acylate]

A cellulose acylate film of the present invention contains a cellulose acylate which is obtained by mixing the following cellulose acetate (A) and the following cellulose acylate (B) in a mixing ratio of the cellulose acetate (A)/the cellulose acylate (B) of 90/10 to 40/60 in mass ratio, and which has a total degree of substitution with acyl group of 2.6 to 2.95, and a degree of substitution with acetyl group of 2.2 to 2.9 and a degree of substitution with acyl group having 3 to 6 carbon atoms of 0.05 to 0.40.

Cellulose acetate (A): a cellulose acetate having a degree of substitution with acetyl group of 2.7 to 2.95

Cellulose acylate (B): a cellulose acylate having a total degree of substitution with acyl group of 2.0 to 2.9 and a degree of substitution with acyl group having 3 to 6 carbon atoms of 0.3 to 1.9

(Cellulose Acylate Raw Material Cotton)

Examples of the cellulose used as a raw material of the cellulose acylate in the invention include cotton linter, wood pulp (broad leaf pulp and needle leaf pulp) and the like. The cellulose acylate may be available from any raw cellulose and, if necessary, may be used in a mixture thereof. Detailed description on these raw celluloses can be found in, for example, “Lecture on Plastic Materials (17) Cellulose Resins” (Maruzawa and Uda, The NIKKAN KOGYO SHIMBUN, Ltd., published in 1970) or Japan Institute of Invention and Innovation, Kokai Giho (Open Technical Report) 2001-1745 (pp. 7 to 8), and the cellulose acylate film of the present invention is not limited thereto.

(Degree of Substitution of Cellulose Acylate)

The cellulose acylate used in the present invention is a product resulting from acylation of hydroxyl groups of cellulose, and the substituents thereof are acetyl groups which are an acyl group having 2 carbon atoms, and acyl groups having 3 to 6 carbon atoms. Further, the acyl groups may have 7 to 22 carbon atoms.

In the cellulose acylate of the present invention, for the degree of substitution of hydroxyl groups of cellulose with acyl groups, the total degree of substitution with acyl group is 2.6 to 2.95, the degree of substitution with acetyl group is 2.2 to 2.9, and the degree of substitution with acyl group having 3 to 6 carbon atoms is 0.05 to 0.40.

The degree of substitution can be obtained by measuring the degree of bonding of acetic acid and fatty acid having 3 to 6 carbon atoms with which the hydroxyl groups of cellulose are substituted, and by calculating. The measurement may be carried out in accordance with ASTM D-817-91.

In the present invention, the cellulose acylate may have a total degree of substitution with acyl group of 2.6 to 2.95, preferably 2.7 to 2.92, and more preferably 2.8 to 2.92.

Preferable cellulose acylate may be obtainable, which is excellent in terms of moisture permeability or water content when the total degree of substitution with acyl group is 2.6 or more, and which is excellent in terms of solubility in a solvent as a dope for film forming when the degree of substitution with acyl group is 2.95 or less.

The cellulose acylate may have a degree of substitution with acetyl group of 2.2 to 2.9, and preferably 2.4 to 2.85.

An excellent cellulose acylate in terms of moisture permeability or water content may be obtained when the degree of substitution with acetyl group is 2.2 or more. And an excellent cellulose acylate in terms of optical performances may be obtained when the degree of substitution with acetyl group is 2.9 or less.

The cellulose acylate may have a degree of substitution with acyl group having 3 to 6 carbon atoms of 0.05 to 0.40, and preferably 0.10 to 0.30.

An excellent cellulose acylate in terms of humidity dependence of optical performances or suppression of bleed-out may be obtained when the degree of substitution with acyl group having 3 to 6 carbon atoms is 0.05 or more. And an excellent cellulose acylate film in terms of film transparency may be obtained when the degree of substitution with acyl group having 3 to 6 carbon atoms is 0.4 or less.

Acyl groups having 3 to 6 carbon atoms, with which the hydroxyl groups of cellulose are substituted, may be used either alone or in a mixture of two or more kinds thereof. Examples of the cellulose acylate which is substituted with such acyl groups may include alkylcarbonyl esters or alkenylcarbonyl esters of cellulose, each of which may be further substituted.

Examples of an acyl group having 3 to 6 carbon atoms may include a propionyl group, a butanoyl group (a butyryl group), an i-butanoyl group, a t-butanoyl group, a pentanoyl group, a hexanoyl group, and the like, and preferably a propionyl group or a butanoyl group.

The cellulose acylate used in the present invention may further include an acyl group having 7 to 22 carbon atoms. An acyl group having 7 to 22 carbon atoms, with which the hydroxyl group of cellulose may be substituted, may be an aliphatic acyl group or an aromatic acyl group, and may be used either alone or in a mixture of two or more kinds thereof. Examples of the cellulose acylate which is substituted with such acyl groups may include alkylcarbonyl esters, alkenylcarbonyl esters, aromatic carbonyl esters or aromatic alkylcarbonyl esters of cellulose, and each of which may be further substituted.

Examples of an acyl group having 7 to 22 carbon atoms may include a heptanoyl group, an octanoyl group, a decanoyl group, a dodecanoyl group, tridecanoyl group, a tetradecanoyl group, a hexadecanoyl group, an octadecanoyl group, a cyclohexanecarbonyl group, an oleoyl group, a benzoyl group, a naphthylcarbonyl group, a cinnamoyl group, and the like.

(Degree of Polymerization of Cellulose Acylate)

The degree of polymerization of cellulose acylate preferably used in the present invention is 180 to 700 as a viscosity average degree of polymerization, and the degree of polymerization of cellulose acetate is more preferably 180 to 550, even more preferably 180 to 400, and particularly preferably 180 to 350. When the degree of polymerization is equal to or less than the upper limit, the viscosity of a dope solution of the cellulose acylate is not excessively increased, and thus it is easy to prepare a film by casting, which is preferred. When the degree of polymerization is equal to or more than the lower limit, problems such as deterioration in strength of the prepared film do not occur, which is preferred. The viscosity average degree of polymerization can be measured by the extreme viscosity method of Uda et al. (Kazuo Uda and Hideo Saito, “Bulletin of The Society of Fiber Science and Technology, Japan”, vol. 18, No. 1, pp. 105-120 (1962)). The method is also described in detail in Japanese Patent Application Laid-Open No. Hei 9-95538.

The molecular weight distribution of the cellulose acylate preferably used in the present invention is evaluated by gel permeation chromatography, and it is preferred that the polydispersity index Mw/Mn (Mw: mass average molecular weight, Mn: number average molecular weight) is small, while the molecular weight distribution is narrow. Specific values of Mw/Mn preferably range from 1.0 to 4.0, more preferably from 2.0 to 4.0, and most preferably from 2.3 to 3.4.

The number average molecular weight Mn of the cellulose acylate preferably ranges from 4×10⁴ to 30×10⁴, and more preferably from 6×10⁴ to 10×10⁴.

An elimination of low-molecular weight components in cellulose acylate results in an increase in average molecular weight (degree of polymerization), but makes the viscosity lower than a typically used cellulose acylate, and thus such elimination is useful. A cellulose acylate having reduced low-molecular components can be obtained by eliminating low-molecular components from cellulose acylate synthesized by a typical method. The elimination of the low-molecular components can be performed by washing the cellulose acylate with an appropriate organic solvent.

When preparing a cellulose acylate having reduced low-molecular components, it is preferred that the amount of a sulfuric acid catalyst in the acetification reaction is adjusted within a range of 0.5 to 25 parts by mass, based on 100 parts by mass of cellulose. The amount of a sulfuric acid catalyst within the aforementioned range makes it possible to synthesize cellulose acylate that is preferable in terms of the molecular weight distribution (with uniform molecular weight distribution).

When the cellulose acylate is used for preparation of a cellulose acylate film of the present invention, the cellulose acylate preferably has a water content of 2% by mass or less, more preferably 1% by mass or less and particularly preferably 0.7% by mass or less. The cellulose acylate is generally known to contain water, in an amount of approximately 2.5 to 5% by mass. In order to attain a preferable water content of the cellulose acylate in the present invention, drying is required, and the method is not particularly limited as long as a desired water content may be attained. For the cellulose acylate, a raw cotton and a synthesizing method are described in detail in Japan Institute of Invention and Innovation, Kokai Giho pp. 7-12 (Technical Publication No. 2001-1745, Mar. 15, 2001, published by Japan Institute of Invention and Innovation).

The cellulose acylate in the present invention can be used either alone or in a mixture of two or more kinds thereof.

The cellulose acylate in the present invention is a mixture of a cellulose acetate (A) having a degree of substitution with acetyl group of 2.7 to 2.95 and a cellulose acylate (B) having a total degree of substitution with acyl group of 2.0 to 2.9 and a degree of substitution with acyl group having 3 to 6 carbon atoms of 0.3 to 1.9. Accordingly, the haze of a cellulose acylate film thus obtained can be preferably lowered.

The cellulose acetate (A) may have a degree of substitution with acetyl group of preferably 2.7 to 2.95, and more preferably 2.8 to 2.95 from the viewpoint of moisture permeability or water content.

The cellulose acetate (A) may have a total degree of substitution with acyl group of 2.7 to 2.95, and preferably 2.8 to 2.95 from the viewpoint of moisture permeability or water content.

The cellulose acylate (B) may have a degree of substitution with acyl group having 3 to 6 carbon atoms of 0.3 to 1.9, and preferably 0.5 to 1.5 from the viewpoint of compatibility with the cellulose acetate (A).

Examples of an acyl group having 3 to 6 carbon atoms may include a propionyl group, a butanoyl group, an i-butanoyl group, a t-butanoyl group, a pentanoyl group, a hexanoyl group, and the like, and preferably a propionyl group or a butanoyl group.

The cellulose acylate (B) may have a total substrate degree of acyl group of 2.0 to 2.9, and preferably 2.3 to 2.8 from the viewpoint of humidity dependence of optical performances and compatibility with the cellulose acetate (A).

From the viewpoint of suppression effects of exudation, humidity dependence of optical performances, and moist heat durability when processed in the form of a polarizing plate, the mixing ratio of the cellulose acetate (A) and cellulose acylate (B) is (A)/(B)=90/10 to 40/60 (by mass), preferably 90/10 to 50/50, and more preferably 80/20 to 60/40.

As described above, as a mixture obtained after mixing the cellulose acetate (A) with the cellulose acylate (B), the cellulose acylate may have a total degree of substitution with acyl group of 2.6 to 2.95, and preferably 2.7 to 2.92.

As a mixture obtained after mixing the cellulose acetate (A) with the cellulose acylate (B), the cellulose acylate may have a degree of substitution with acetyl group of 2.2 to 2.9, and preferably 2.4 to 2.85.

As a mixture obtained after mixing the cellulose acetate (A) with the cellulose acylate (B), the cellulose acylate may have a degree of substitution with acyl group having 3 to 6 carbon atoms of 0.05 to 0.40, and preferably 0.10 to 0.30.

The degree of substitution with acyl group of a mixture of two or more cellulose acylates may be calculated as a mass average of acyl groups of each cellulose acylate mixed. The measurement of the degree of substitution with acyl group according to the present invention can be carried out in accordance with ASTM D-817-91.

[Plasticizers]

A cellulose acylate film of the present invention contains a plasticizer in an amount of 30% to 65% by mass based on the cellulose acylate.

Plasticizers which can be used in the cellulose acylate film of the present invention are not particularly limited, but may include phosphoric acid ester-based plasticizers, phthalic acid ester-based plasticizers, polyhydric alcohol ester-based plasticizers, polyhydric carboxylic acid ester-based plasticizers, glycolate-based plasticizers, citric acid ester-based plasticizers, aliphatic acid ester-based plasticizers, carboxylic acid ester-based plasticizers, polyester oligomer-based plasticizers, sugar ester-based plasticizers, nitrogen containing aromatic compound-based plasticizers, ethylenically unsaturated monomer copolymer-based plasticizers, and the like.

The plasticizers preferably include phthalic acid ester-based compounds, polyhydric alcohol ester-based plasticizers, polyester oligomer-based plasticizers, citric acid ester-based plasticizers, sugar ester-based plasticizers and nitrogen containing aromatic compound-based plasticizers, and more preferably polyester oligomer-based plasticizers.

In particular, polyester oligomer-based plasticizers, polyhydric alcohol ester-based plasticizers, and sugar ester-based plasticizers are preferred because the plasticizers have high compatibility with cellulose acylate, reduced bleed out, and high effects of low haze and low moisture permeability, and decomposition of the plasticizers and degeneration or deformation of films are hardly caused by change in temperature and humidity and passage of time. From the same viewpoint, furthermore, polyester oligomer-based plasticizers and sugar ester-based plasticizers are preferable, and polyester oligomer-based plasticizers are particularly preferable.

In the present invention, plasticizers can be used either alone or in a mixture of two or more kinds thereof.

In the cellulose acylate film of the present invention, plasticizers are contained in an amount of 30% to 65% by mass, and from the viewpoint of humidity dependence of optical performances and bleed-out, preferably 40% to 60% by mass, and more preferably 45% to 55% by mass, based on the cellulose acylate.

(Phosphoric Acid Ester-Based Plasticizers)

Phosphoric acid ester-based plasticizers are not particularly limited, but may include triphenyl phosphate (TPP), tricresyl phosphate (TCP), cresyl diphenyl phosphate, octyl diphenyl phosphate, diphenyl biphenyl phosphate (BDP), trioctyl phosphate, tributyl phosphate, and the like.

(Phthalic Acid Ester-Based Plasticizers)

Phthalic acid ester-based plasticizer are not particularly limited, but may include diethyl phthalate, dimethoxy ethylphthalate, methylphthalate, dioctyl phthalate, dibutyl phthalate, di-2-ethylhexyl phthalate, butylbenzyl phthalate, dibenzyl phthalate, and the like.

(Glycolate-Based Plasticizers)

Glycolate-based plasticizers are not particularly limited, but alkylphthalylalkyl glycolates can be preferably used.

Examples of the alkylphthalylalkyl glycolates may include methylphthalylmethyl glycolate, ethylphthalylethyl glycolate, propylphthalylpropyl glycolate, butylphthalylbutyl glycolate, octylphthalyloctyl glycolate, methylphthalylethyl glycolate, ethylphthalylmethyl glycolate, ethylphthalylpropyl glycolate, methylphthalylbutyl glycolate, ethylphthalylbutyl glycolate, butylphthalylmethyl glycolate, butylphthalylethyl glycolate, propylphthalylbutyl glycolate, butylphthalylpropyl glycolate, methylphthalyloctyl glycolate, ethylphthalyloctyl glycolate, octylphthalylmethyl glycolate, octylphthalylethyl glycolate, and the like.

(Polyhydric Alcohol Ester-Based Plasticizers)

Polyhydric alcohol ester-based plasticizers are plasticizers including esters of dihydric or more aliphatic alcohols with monocarboxylic acids, and preferably have aromatic rings or cycloalkyl rings in the molecule. Preferably, the polyhydric alcohol ester-based plasticizers are 2- to 20-hydric aliphatic polyhydric alcohol esters.

Examples of polyhydric alcohols, which can be preferably used in the present invention, may include the following alcohols, however the present invention is not limited thereto.

Examples of the polyhydric alcohols may include adonitol, arabitol, ethylene glycol, diethylene glycol, triethylene glycol, tetraethylene glycol, 1,2-propanediol, 1,3-propanediol, dipropylene glycol, tripropylene glycol, 1,2-butanediol, 1,3-butanediol, 1,4-butanediol, dibutylene glycol, 1,2,4-butanetriol, 1,5-pentanediol, 1,6-hexanediol, hexanetriol, galactitol, mannitol, 3-methylpentane-1,3,5-triol, pinacol, sorbitol, trimethylolpropane, trimethylolethane, xylitol, and the like.

In particular, triethylene glycol, tetraethylene glycol, dipropylene glycol, tripropylene glycol, sorbitol, trimethylolpropane and xylitol are preferable.

Mono carboxylic acids to be used for the polyalcohol esters are not particularly limited, and well known compounds such as aliphatic monocarboxylic acid, alicyclic monocarboxylic acid, aromatic monocarboxylic acid, and the like can be used. Alicyclic monocarboxylic acid or aromatic monocarboxylic acid is preferable in that moisture permeability and retainability may be improved when the acids are used.

Examples of preferable monocarboxylic acids are listed below, however, the present invention is not limited thereto.

For aliphatic monocarboxylic acids, straight or branched fatty acids having 1 to 32 carbon atoms may be preferably used. The number of carbon atoms is more preferably 1 to 20 and particularly preferably 1 to 10. An acetic acid is preferable because the compatibility with cellulose acylate may be improved if the acid is contained, and thus a mixture of an acetic acid and other monocarboxylic acids is also preferable.

Examples of preferable aliphatic monocarboxylic acids may include saturated fatty acids such as acetic acid, propionic acid, butyric acid, valeric acid, caproic acid, enanthic acid, caprylic acid, pelargonic acid, capric acid, 2-ethyl-hexanoic acid, undecylic acid, lauric acid, tridecylic acid, myristic acid, pentadecylic acid, palmitic acid, heptadecylic acid, stearic acid, nonadecane acid, arachidic acid, behenic acid, lignoceric acid, cerotinic acid, heptacosanoic acid, montanic acid, melissic acid, lacceric acid, and the like; and unsaturated fatty acids such as: undecylenic acid, oleic acid, sorbic acid, linoleic acid, linolenic acid, arachidonic acid, and the like.

Examples of preferable alicyclic monocarboxylic acids may include cyclopentane carboxylic acid, cyclohexane carboxylic acid and cyclooctane carboxylic acid, or derivatives thereof.

Examples of preferable aromatic monocarboxylic acids may include those which have 1 to 3 alkoxy groups, such as an alkyl group, a methoxy group or an ethoxy group introduced to a benzene ring of benzoic acid, such as benzoic acid, toluic acid, and the like; aromatic monocarboxylic acids which have 2 or more benzene rings, such as biphenyl carboxylic acid, naphthalenecarboxylic, tetralincarboxylic acid, and the like; derivatives thereof. Benzoic acid is particularly preferred.

The molecular weight of the polyhydric alcohol ester is not particularly limited, however, the molecular weight is preferably 300 to 1,500 and more preferably 350 to 750. When the molecular weight is within the above range, the polyhydric alcohol ester is preferable in that the volatility of the polyhydric alcohol ester is reduced, and moisture permeability and compatibility with cellulose acylate are excellent.

Carboxylic acids to be used for polyhydric alcohol esters may be used either alone or in a mixture of two or more kinds thereof. Hydroxyl groups in a polyhydric alcohol may be completely esterified, or only partially esterified such that some hydroxyl groups still remain.

(Polyester Oligomer-Based Plasticizers)

Polyester oligomers in the present invention are a polycondensate obtained by, for example, mixing diol with dicarboxylic acid.

The number average molecular weight of the polyester oligomer is preferably 800 to 5,000, more preferably 850 to 3,000, even more preferably 900 to 2,000, and particularly preferably 900 to 1,250. When the number average molecular weight of the polyester oligomer is 800 or more, the volatility is decreased, thereby making it difficult to cause film failure or process contamination by volatilization under high temperature conditions during stretching of the cellulose acylate film. If the number average molecular weight is 2,500 or less, the compatibility with the cellulose acylate is increased, and thus it is difficult to generate bleed-out during film-forming and heating/stretching.

The number average molecular weight of the polyester oligomer can be measured by a typical method by means of GPC (Gel Permeation Chromatography).

For example, measurement can be carried out at a temperature of columns (TSKgel Super HZM-H, TSKgel Super HZ4000, and TSKgel Super HZ2000, manufactured by TOSOH CORPORATION) set at 40° C., using THF as an eluent, at a flow rate of 0.35 ml/min, and using RI for a detection, a feed amount of 10 μl, a sample concentration of 1 g/l and polystyrene as a standard sample.

Dicarboxylic acids may include aromatic dicarboxylic acids and aliphatic dicarboxylic acids. These dicarboxylic acids are included as a dicarboxylic acid residue to form an ester bond with a diol residue in the polyester oligomer.

(Aromatic Dicarboxylic Acid Residue)

An aromatic dicarboxylic acid residue is included in a polycondensate obtained from a diol and a dicarboxylic acid including an aromatic dicarboxylic acid.

The aromatic dicarboxylic acid residue refers to a partial structure of a polyester oligomer, and represents a partial structure having the characteristics of the monomers constituting the polyester oligomer. For example, the dicarboxylic acid residue formed from the dicarboxylic acid HOOC—R—COOH is —OC—R—CO—.

The ratio of the aromatic dicarboxylic acid residues in the whole dicarboxylic acid residues constituting the polyester oligomer used in the present invention is not particularly limited, however, the ratio ranges preferably from 40 mol % to 100 mol %, more preferably from 45 mol % to 70 mol %, and even more preferably from 50 mol % to 70 mol %.

By setting the ratio of the aromatic dicarboxylic acid residues to 40 mol % or more, a cellulose acylate film exhibiting sufficient optical anisotropy can be obtained. If the ratio of the aromatic dicarboxylic acids is decreased, the compatibility with the cellulose acylate is excellent and it can make difficult to generate bleed-out even during forming the cellulose acylate film and even during heating and stretching.

Examples of the aromatic dicarboxylic acid used in the present invention may include phthalic acid, terephthalic acid, isophthalic acid, 1,5-naphthalene dicarboxylic acid, 1,4-naphthalene dicarboxylic acid, 1,8-naphthalene dicarboxylic acid, 2,8-naphthalene dicarboxylic acid, 2,6-naphthalene dicarboxylic acid, and the like.

In the polyester oligomer, an aromatic dicarboxylic acid residue is formed by the aromatic dicarboxylic acid used in the mixing.

The aromatic dicarboxylic acid preferably has an average carbon number of 8.0 to 12.0, more preferably 8.0 to 10.0, and even more preferably 8.0. Within this range, the compatibility with the cellulose acylate is excellent and it is difficult to generate bleed-out even during forming the cellulose acylate film and even during heating and stretching, which is thus preferred. The aromatic dicarboxylic acid residue can be used to make a cellulose acylate film capable of sufficiently developing anisotropy suitable for use in the optically-compensatory films in optical applications, which thus it is preferred.

Specifically, the aromatic dicarboxylic acid preferably contains at least one of phthalic acid, terephthalic acid, and isophthalic acid, more preferably at least one of phthalic acid and terephthalic acid, and even more preferably terephthalic acid.

That is, by using terephthalic acid as an aromatic dicarboxylic acid in mixing in the formation of a polyester oligomer, a cellulose acylate film can be made, in which the compatibility with the cellulose acylate is excellent and it is difficult to generate bleed-out even during forming the cellulose acylate film and even during heating and stretching. The aromatic dicarboxylic acids may be used either alone or in a mixture of two or more kinds thereof. When two kinds thereof are used, it is preferable to use phthalic acid and terephthalic acid.

By using phthalic acid and terephthalic acid as two kinds of aromatic dicarboxylic acid in combination, the polyester oligomer can be softened at an ambient temperature, which is thus preferred in terms of making handling easy.

The content of the terephthalic acid residues in the total dicarboxylic acid residues constituting the polyester oligomer is not particularly limited, however, the content ranges preferably from 40 mol % to 95 mol %, more preferably from 40 mol % to 70 mol %, and even more preferably from 45 mol % to 60 mol %.

By setting the ratio of the terephthalic acid residues to 40 mol % or more, a cellulose acylate film exhibiting sufficient optical anisotropy can be obtained. If the ratio is 95 mol % or less, the compatibility with the cellulose acylate is excellent and it can be made difficult to generate bleed-out even during forming the cellulose acylate film and even during heating and stretching.

(Aliphatic Dicarboxylic Acid Residue)

An aliphatic dicarboxylic acid residue is included in a polycondensate obtained from a diol and a dicarboxylic acid including an aliphatic dicarboxylic acid.

As used herein, the aliphatic dicarboxylic acid residue refers to a partial structure of a polyester oligomer, and represents a partial structure having the characteristics of the monomers constituting the polyester oligomer. For example, the dicarboxylic acid residue formed from the dicarboxylic acid HOOC—R—COOH is —OC—R—CO—. Where, R represents a divalent hydrocarbon group.

Examples of the aliphatic dicarboxylic acid which is preferably used in the present invention may include oxalic acid, malonic acid, succinic acid, maleic acid, fumaric acid, glutaric acid, adipic acid, pimelic acid, suberic acid, azelaic acid, sebacic acid, dodecane dicarboxylic acid, 1,4-cyclohexane dicarboxylic acid, and the like.

In the polycondensate, an aliphatic dicarboxylic acid residue is formed from the aliphatic dicarboxylic acid used in mixing.

The aliphatic dicarboxylic acid residue has an average carbon number, which is not particularly limited, however, the residue preferably has an average carbon number of 4.0 to 6.0, more preferably 4.0 to 5.0, and even more preferably 4.0 to 4.8. Within this range, the compatibility with the cellulose acylate is excellent and it is difficult to generate bleed-out even during forming the cellulose acylate film and even during heating and stretching, which is thus preferred.

Specifically, it is preferable to contain a succinic acid residue, and when two kinds thereof are used, it is preferable to contain a succinic acid residue and an adipic acid residue.

That is, one or two kinds or more of the aliphatic dicarboxylic acids may be used in mixing in the formation of a polyester oligomer, and when two kinds thereof are used, succinic acid and adipic acid are preferably used.

By using succinic acid and adipic acid as two kinds of the aliphatic dicarboxylic acids, the average carbon number of the diol residue can be reduced, which is thus preferred in terms of compatibility with the cellulose acylate.

The average carbon number of the aliphatic dicarboxylic acid residue of less than 4.0 makes the synthesis difficult, and thus aliphatic dicarboxylic acid cannot be used.

(Diol)

A diol residue is included in a polyester oligomer obtained from a diol and a dicarboxylic acid.

As used herein, the diol residue refers to a partial structure of a polyester oligomer, and represents a partial structure having the characteristics of the monomers constituting the polyester oligomer. For example, the dicarboxylic acid residue formed from the diol HO—R—OH is —O—R—O—. Here, R represents a divalent hydrocarbon group.

Examples of the diol which forms the polyester oligomer include an aromatic diol and an aliphatic diol, and although the diol is not particularly limited, the aliphatic diol is preferred.

The diol of the polyester oligomer is not particularly limited, however, the diol includes an aliphatic diol residue preferably having an average carbon number of 2.0 to 3.0, more preferably an aliphatic diol residue having an average carbon number of 2.0 to 2.8, and even more preferably an average carbon number of 2.0 to 2.5. If the average carbon number of the aliphatic diol residue is more than 3.0, the compatibility with the cellulose acylate is low and the bleed-out easily occurs, a loss on heating of the compound increases, and thus, surface-state failure is generated, which is believed to result from process contamination during drying the cellulose acylate is generated. If the average carbon number of the aliphatic diol residue is less than 2.0, the synthesis becomes difficult, and thus the diol cannot be used.

Examples of the aliphatic diol used in the present invention include alkyl diols or cycloaliphatic diols, for example, ethylene glycol, 1,2-propanediol, 1,3-propanediol, 1,2-butanediol, 1,3-butanediol, 2-methyl-1,3-propanediol, 1,4-butanediol, 1,5-pentanediol, 2,2-dimethyl-1,3-propanediol (neopentyl glycol), 2,2-diethyl-1,3-propanediol (3,3-dimethylolpentane), 2-n-butyl-2-ethyl-1,3-propanediol (3,3-dimethylolheptane), 3-methyl-1,5-pentanediol, 1,6-hexanediol, 2,2,4-trimethyl-1,3-pentanediol, 2-ethyl-1,3-hexanediol, 2-methyl-1,8-octanediol, 1,9-nonanediol, 1,10-decanediol, 1,12-octadecanediol, diethylene glycol, and the like, and these are preferably used as a mixture of one kind or two or more kinds thereof in combination with ethylene glycol.

Preferable aliphatic diols are at least one of ethylene glycol, 1,2-propanediol, and 1,3-propanediol, and particularly preferably at least one of ethylene glycol and 1,2-propanediol. When two kinds thereof are used, it is preferable to use ethylene glycol and 1,2-propanediol.

In the polyester oligomer, a diol residue is formed by the diol used in mixing.

Examples of the diol residue preferably include at least one of an ethylene glycol residue, a 1,2-propanediol residue and a 1,3-propanediol residue, and more preferably an ethylene glycol residue or a 1,2-propanediol residue.

Among the aliphatic diol residues, ethylene glycol residues are preferably at 20 mol % to 100 mol %, and more preferably at 50 mol % to 100 mol %.

(Capping)

Both terminals of the polyester oligomer of the present invention may or may not be capped, and more preferably capped.

When both terminals of the polyester oligomer are not capped, the polycondensate is preferably a polyester polyol (having a hydroxyl group at the terminal thereof).

When both terminals of the polyester oligomer are capped, it is preferable to allow it to undergo a reaction with a monocarboxylic acid to perform capping. At this time, both terminals of the polycondensate are composed of monocarboxylic acid residues.

As used herein, the monocarboxylic acid residue refers to a partial structure of a polyester oligomer, and represents a partial structure having the characteristics of the monomers constituting the polyester oligomer. For example, the monocarboxylic acid residue formed from the monocarboxylic acid R—COOH is R—CO—. The capping with the monocarboxylic acid may be performed by using either of aromatic monocarboxylic acid or aliphatic carboxylic acid.

The kind of the capping with the monocarboxylic acid is not particularly limited, however, the monocarboxylic acid used for capping is preferably an aliphatic monocarboxylic acid residue, more preferably an aliphatic monocarboxylic acid residue having 2 to 22 carbon atoms, even more preferably an aliphatic monocarboxylic acid residue having 2 to 3 carbon atoms, and particularly preferably an aliphatic monocarboxylic acid residue having 2 carbon atoms.

If the carbon number of the monocarboxylic acid residue at both terminals of the polyester oligomer is 3 or less, the volatility is lowered, a loss on heating of the polycondensate is not significant, and it is possible to reduce generation of process contamination or failure of the surface state.

For example, acetic acid, propionic acid, butanoic acid, benzoic acid, and derivatives thereof are preferred, acetic acid or propionic acid is more preferred, and acetic acid is most preferred.

The monocarboxylic acids used for capping may be in a mixture of two or more kinds thereof.

Both terminals of the polyester oligomer of the present invention are preferably capped with acetic acid or propionic acid, and both terminals are most preferably capped with acetic acid so that both the capped terminals are acetyl ester residues (sometimes referred to as acetyl residues).

When both terminals are capped, it is difficult for the state at an ambient temperature to become a solid form, and thus handleability is improved. A cellulose acylate film which is excellent in humidity stability and polarizing plate durability can be obtained.

The polyester oligomer according to the present invention can be easily synthesized in a typical way by any one of a hot melt condensation process by a polyesterification reaction or a transesterification reaction between a diol and a dicarboxylic acid, and an interface condensation process with acid chlorides of these acids and glycols. The polyester oligomer according to the present invention is described in detail in Koichi Murai, “Plasticizer-Theory and Application” (First Edition, First Impression, published by Saiwai Shobo, Mar. 1, 1973). The materials disclosed in Japanese Patent Application Laid-Open Nos. Hei 05-155809, Hei 05-155810, Hei 05-197073, 2006-259494, Hei 07-330670, 2006-342227, 2007-003679 and the like can be used.

The content of aliphatic diol, dicarboxylic acid ester or diol ester as a raw material contained in the polyester oligomer of the present invention is preferably less than 1% by mass, and more preferably less than 0.5% by mass in the cellulose acylate film. Examples of the dicarboxylic acid ester may include dimethyl phthalate, di(hydroxyethyl)phthalate, dimethyl terephthalate, di(hydroxyethyl)terephthalate, di(hydroxyethyl)adipate, di(hydroxyethyl)succinate, and the like. Examples of the diol ester may include ethylene diacetate, propylene diacetate, and the like.

An acetic anhydride method as described in Japan Industrial Standard JIS K3342 (abolished) can be applied for measurement of the hydroxyl value of the polyester oligomer. When the polyester oligomer is a polyester polyol, the hydroxyl value is preferably 55 or more and 220 or less, and more preferably 100 or more and 140 or less.

(Sugar Ester-Based Plasticizers)

Preferred examples of sugar ester-based plasticizers include ester compounds in which at least one hydroxyl group is esterified in a compound having 1 to 12 furanose structural units or pyranose structural units.

The ester compounds in which at least one hydroxyl group is esterified in a compound having 1 to 12 furanose structural units or pyranose structural units may include:

an esterified compound in which the whole or a part of hydroxyl groups is esterified in a compound (compound (A1)) having one furanose structural unit or pyranose structural unit; and

an esterified compound in which the whole or a part of hydroxyl groups is esterified in a compound (compound (B1)), in which 2 to 12 of at least one kind of furanose structural units or pyranose structural units are bound together.

Hereinafter, esterified compounds of the compound (A1) and esterified compounds of the compound (B1) collectively will be also referred to as sugar ester compounds.

The esterified compound is preferably benzoic acid ester of monosaccharides (α-glucose, β-fructose) or benzoic acid ester of polysaccharides produced by dehydration condensation of any two or more of —OR⁵¹², —OR⁵¹⁵, —OR⁵²² and —OR⁵²⁵ in monosaccharide represented by the following general formula (5), in which m₅+n₅=2 to 12.

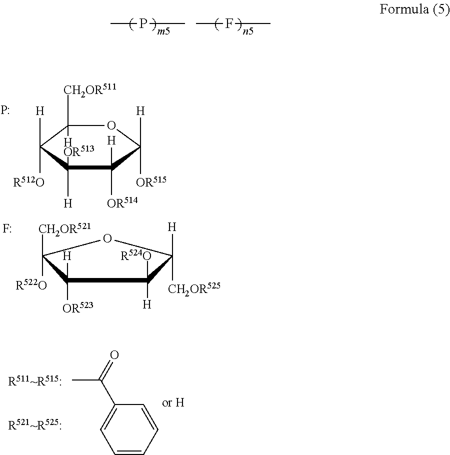

The benzoic acid in the general formula may further have substituent(s), which include(s), for example, an alkyl group, an alkenyl group, an alkoxy group and a phenyl group, and the alkyl group, alkenyl group and phenyl group thereof may further have substituent(s).

Preferred examples of the compound (A1) and compound (B1) include the following, however, the present invention is not limited thereto.

Examples of the compound (A1) may include glucose, galactose, mannose, fructose, xylose or arabinose.

Examples of the compound (B1) may include lactose, sucrose, nystose, 1F-fructosyl nystose, stachyose, maltitol, lactitol, lactulose, cellobiose, maltose, cellotriose, maltotriose, raffinose or kestose. In addition to these, gentiobiose, gentiotriose, gentiotetraose, xylotriose, galactosylsucrose, and the like may be further exemplified.

Among the compound (A1) and the compound (B1), compounds having both of a pyranose structure and a furanose structure are particularly preferred. As an example, sucrose, kestose, nystose, 1F-fructosyl nystose and stachyose are preferred, and sucrose is more preferred. In the compound (B1), compounds in which 2 to 3 of at least one of a furanose structure or a pyranose structure are bound together are one of preferred aspects.

Monocarboxylic acid used for esterification of the whole or a part of hydroxyl groups in the compound (A1) and the compound (B1) in the present invention is not particularly limited, and well known aliphatic monocarboxylic acids, alicyclic monocarboxylic acids and aromatic monocarboxylic acids are available. Available carboxylic acids may be used either alone or in a mixture of two or more kinds thereof.

Examples of preferable aliphatic monocarboxylic acids may include saturated fatty acids, such as acetic acid, propionic acid, butyric acid, isobutyric acid, valeric acid, caproic acid, enanthic acid, caprylic acid, pelargonic acid, capric acid, 2-ethyl-hexane carboxylic acid, undecylic acid, lauric acid, tridecylic acid, myristic acid, pentadecylic acid, palmitic acid, heptadecylic acid, stearic acid, nonadecane acid, arachidic acid, behenic acid, lignoceric acid, cerotinic acid, heptacosanoic acid, montanic acid, melissic acid, lacceric acid, and the like; and unsaturated fatty acids, such as undecylenic acid, oleic acid, sorbic acid, linoleic acid, linolenic acid, arachidonic acid, octenoic acid and the like.

Examples of preferable alicyclic monocarboxylic acids may include cyclopentane carboxylic acid, cyclohexane carboxylic acid, cyclooctane carboxylic acid, or derivatives thereof.

Examples of preferable aromatic monocarboxylic acids may include aromatic monocarboxylic acid in which an alkyl group or an alkoxy group is introduced to a benzene ring of benzoic acid, such as benzoic acid and toluic acid; aromatic monocarboxylic acid having at least two benzene rings, such as cinnamic acid, benzilic acid, biphenyl carboxylic acid, naphthalene carboxylic acid, tetralin carboxylic acid, and the like, or derivatives thereof; more specifically, include xylylic acid, hemellitic acid, mesitylenic acid, prehnitylic acid, γ-isodurylic acid, durylic acid, mesitonic acid, α-isodurylic acid, cuminic acid, α-toluic acid, hydroatropic acid, atropic acid, hydrocinnamic acid, salicylic acid, o-anisic acid, m-anisic acid, p-anisic acid, creosotic acid, o-homosalicylic acid, m-homosalicylic acid, p-homosalicylic acid, o-pyrocatechuic acid, β-resorcylic acid, vanillic acid, isovanillic acid, veratric acid, o-veratric acid, gallic acid, asaronic acid, mandelic acid, homoanisic acid, homovanillic acid, homoveratric acid, o-homoveratric acid, phthalonic acid and p-coumaric acid. Benzoic acid is particularly preferable.

Among esterified compounds in which the compound (A1) and the compound (B1) are esterified, acetylated compounds, in which acetyl groups are introduced by esterification, are preferable.

These acetylated compounds may be prepared by a method described, for example, in Japanese Patent Application Laid-Open No. Hei 8-245678.

In addition to the esterified compounds of the compound (A1) and the compound (B1), esterified compounds of oligosaccharide can be applied as compounds in which 3 to 12 of at least one of a furanose structural unit and a pyranose structural unit is bound together.

Oligosaccharide is manufactured by acting an enzyme such as amylase, and the like on starch, saccharose, and the like, and examples of oligosaccharide applicable in the present invention may include maltooligosaccharide, isomaltooligosaccharide, fructooligosaccharide, galactooligosaccharide and xylooligosaccharide.

Oligosaccharide can be also acetylated in the same manner as in the compound (A1) and compound (B1).

(Ethylenically Unsaturated Monomer Copolymer-Based Plasticizers)

Ethylenically unsaturated monomers constituting an ethylenically unsaturated monomer copolymer are not particularly limited, however, the following monomers are preferably used.

Examples may include unsaturated compounds, such as methacrylic acid and ester derivatives thereof (methyl methacrylate, ethyl methacrylate, propyl methacrylate, butyl methacrylate, i-butyl methacrylate, t-butyl methacrylate, octyl methacrylate, cyclohexyl methacrylate, 2-hydroxyethyl methacrylate, 2-hydroxypropyl methacrylate, tetrahydrofurfuryl methacrylate, benzyl methacrylate, dimethylaminoethyl methacrylate, diethylaminoethyl methacrylate, and the like), acrylic acid and ester derivatives thereof (methyl acrylate, ethyl acrylate, propyl acrylate, butyl acrylate, i-butyl acrylate, t-butyl acrylate, octyl acrylate, cyclohexyl acrylate, 2-hydroxyethyl acrylate, 2-hydroxypropyl acrylate, tetrahydrofurfuryl acrylate, 2-ethoxyethyl acrylate, diethylene glycol ethoxylate acrylate, 3-methoxybutyl acrylate, benzyl acrylate, dimethylaminoethyl acrylate, diethylaminoethyl acrylate, and the like), alkyl vinyl ether (methyl vinyl ether, ethyl vinyl ether, butyl vinyl ether, and the like), alkyl vinyl ester (vinyl formate, vinyl acetate, vinyl butyrate, vinyl capronate, vinyl stearate, and the like), styrene derivatives (for example, styrene, α-methylstyrene, o-methylstyrene, m-methylstyrene, p-methylstyrene, vinylnaphthalene, and the like), crotonic acid, maleic acid, fumaric acid, itaconic acid, acrylonitrile, methacrylonitrile, vinyl chloride, vinylidene chloride, acrylamide, N,N-dimethylacrylamide, methacrylamide, and the like. These can be used either alone or in a mixture of two kinds thereof, and copolymerized with ethylenically unsaturated monomers having a partial structure represented by the general formula (6) described below in the molecule.

Among these ethylenically unsaturated monomers, ester acrylate or ester methacrylate (for example, methyl methacrylate, ethyl methacrylate, propyl methacrylate, butyl methacrylate, methyl acrylate, ethyl acrylate, propyl acrylate, butyl acrylate), alkyl vinyl ester (vinyl formate, vinyl acetate, vinyl butyrate, vinyl capronate, vinyl stearate, and the like), styrene derivatives (for example, styrene, α-methylstyrene, o-methylstyrene, m-methylstyrene, p-methylstyrene, vinylnaphthalene, and the like) are preferable, methyl methacrylate and methyl acrylate are more preferable, and methyl methacrylate is most preferable.

The number average molecular weight of the ethylenically unsaturated monomer used in the present invention is not particularly limited, however, preferably ranges from 800 to 30,000, more preferably from 900 to 10,000, even more preferably from 1,000 to 5,000, and particularly preferably from 1,000 to 3,000.

The number average molecular weight can be measured by a typical method by means of GPC (Gel Permeation Chromatography).

For example, measurement can be carried out at a temperature of columns (TSKgel Super HZM-H, TSKgel Super HZ4000, and TSKgel Super HZ2000, manufactured by TOSOH CORPORATION) set at 40° C., using THF as an eluent, at a flow rate of 0.35 ml/min, and using RI for a detection, a feed amount of 10 μl, a sample concentration of 1 g/l and polystyrene as a standard sample.

(Nitrogen Containing Aromatic Compound-Based Plasticizers)

Nitrogen containing aromatic compound-based plasticizers have any one of pyridine, pyrimidine, triazine, and purine as a mother nucleus, and an alkyl group, an alkenyl group, an alkynyl, an amino group, an amide group, an aryl group, an alkoxy group, a thioalkoxy group or a heterocyclic group as a substituent at any one substitutable position.

Specific examples of nitrogen containing aromatic compounds are listed below, however, the present invention is not limited thereto.

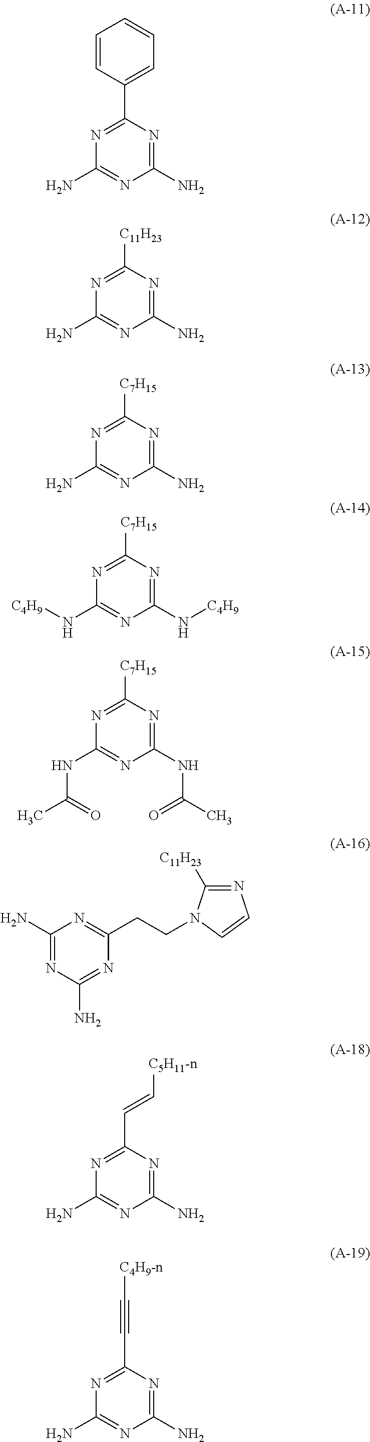

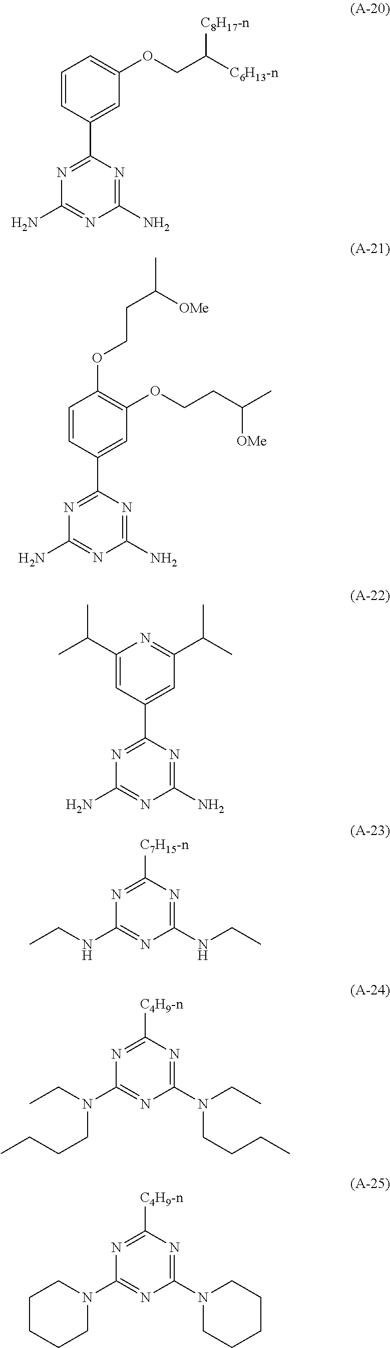

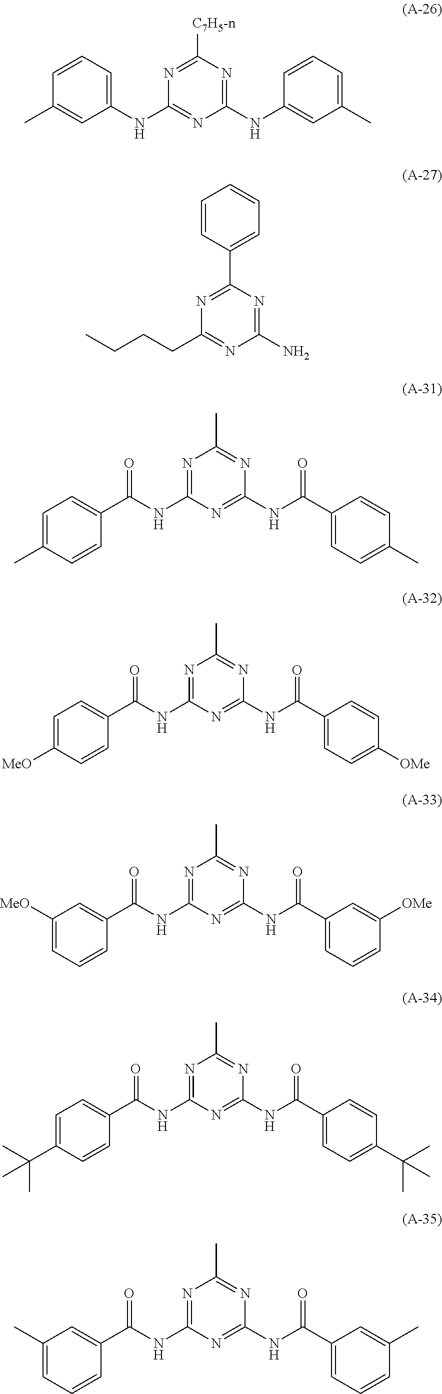

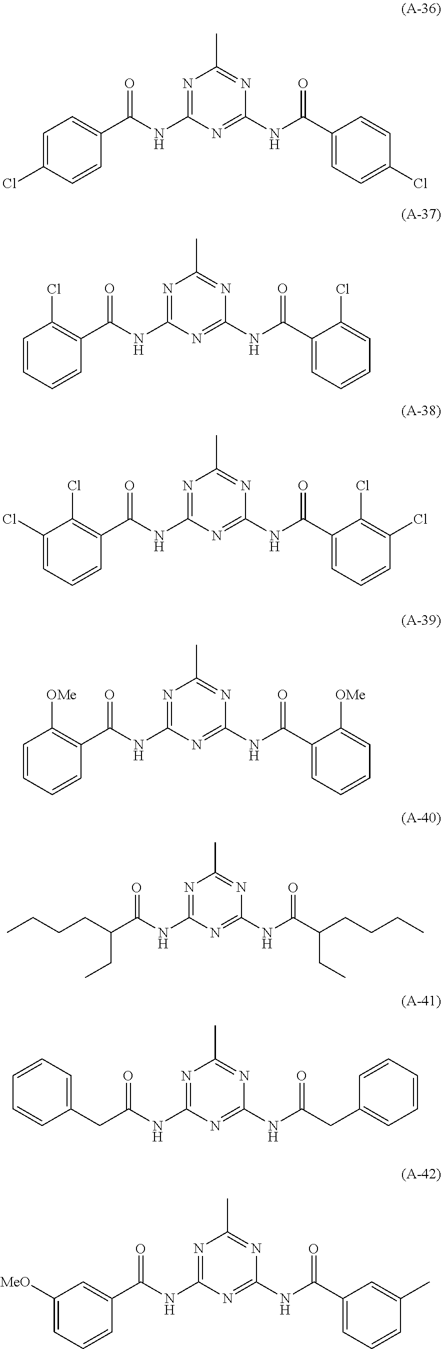

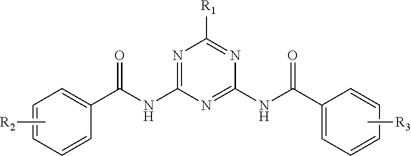

| Compound | R1 | R2 | R3 |
|---|---|---|---|
| C-101 C-102 C-103 C-104 C-105 C-106 C-107 C-108 C-109 C-110 | 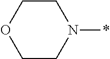 | H o-Me m-Me p-Me o-OMe m-OMe p-OMe p-t-Bu m-Cl m-F | H o-Me m-Me p-Me o-OMe m-OMe p-OMe p-t-Bu m-Cl m-F |
| C-111 C-112 C-113 C-114 C-115 C-116 C-117 C-118 C-119 C-120 | 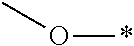 | H o-Me m-Me p-Me o-OMe m-OMe p-OMe p-t-Bu m-Cl m-F | H o-Me m-Me p-Me o-OMe m-OMe p-OMe p-t-Bu m-Cl m-F |
| C-121 C-122 C-123 C-124 C-125 C-126 C-127 C-128 C-129 C-130 | 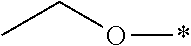 | H o-Me m-Me p-Me o-OMe m-OMe p-OMe p-t-Bu m-Cl m-F | H o-Me m-Me p-Me o-OMe m-OMe p-OMe p-t-Bu m-Cl m-F |
| C-131 C-132 C-133 C-134 C-135 C-136 C-137 C-138 C-139 C-140 | 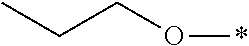 | H o-Me m-Me p-Me o-OMe m-OMe p-OMe p-t-Bu m-Cl m-F | H o-Me m-Me p-Me o-OMe m-OMe p-OMe p-t-Bu m-Cl m-F |
| C-141 C-142 C-143 C-144 C-145 C-146 C-147 C-148 C-149 C-150 | H₂N—* | H o-Me m-Me p-Me o-OMe m-OMe p-OMe p-t-Bu m-Cl m-F | H o-Me m-Me p-Me o-OMe m-OMe p-OMe p-t-Bu m-Cl m-F |
| C-151 C-152 C-153 C-154 C-155 C-156 C-157 C-158 C-159 C-160 | 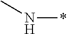 | H o-Me m-Me p-Me o-OMe m-OMe p-OMe p-t-Bu m-Cl m-F | H o-Me m-Me p-Me o-OMe m-OMe p-OMe p-t-Bu m-Cl m-F |
| C-161 C-162 C-163 C-164 C-165 C-166 C-167 C-168 C-169 C-170 | 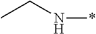 | H o-Me m-Me p-Me o-OMe m-OMe p-OMe p-t-Bu m-Cl m-F | H o-Me m-Me p-Me o-OMe m-OMe p-OMe p-t-Bu m-Cl m-F |
| C-171 C-172 C-173 C-174 C-175 C-176 C-177 C-178 C-179 C-180 | 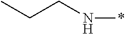 | H o-Me m-Me p-Me o-OMe m-OMe p-OMe p-t-Bu m-Cl m-F | H o-Me m-Me p-Me o-OMe m-OMe p-OMe p-t-Bu m-Cl m-F |

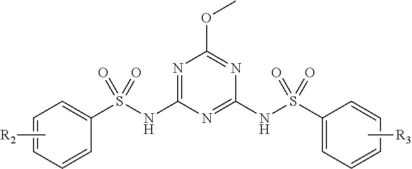

| Compound | R2 | R3 |
|---|---|---|
| C-181 | H | H |
| C-182 | o-Me | o-Me |
| C-183 | m-Me | m-Me |
| C-184 | p-Me | p-Me |
| C-185 | o-OMe | o-OMe |
| C-186 | m-OMe | m-OMe |
| C-187 | p-OMe | p-OMe |
| C-188 | p-t-Bu | p-t-Bu |
| C-189 | m-Cl | m-Cl |
| C-190 | m-F | m-F |

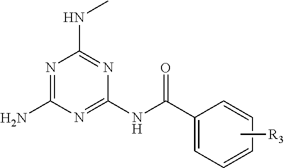

| Compound | R3 |
|---|---|
| D-101 | H |
| D-102 | o-Me |
| D-103 | m-Me |
| D-104 | p-Me |
| D-105 | o-OMe |
| D-106 | m-OMe |
| D-107 | p-OMe |
| D-108 | p-t-Bu |
| D-109 | m-Cl |
| D-110 | m-F |

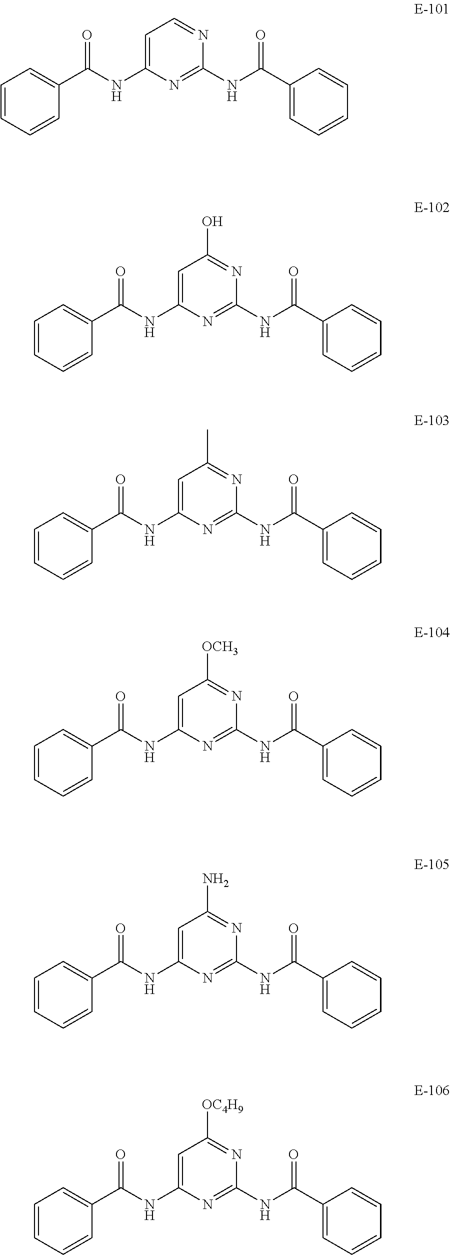

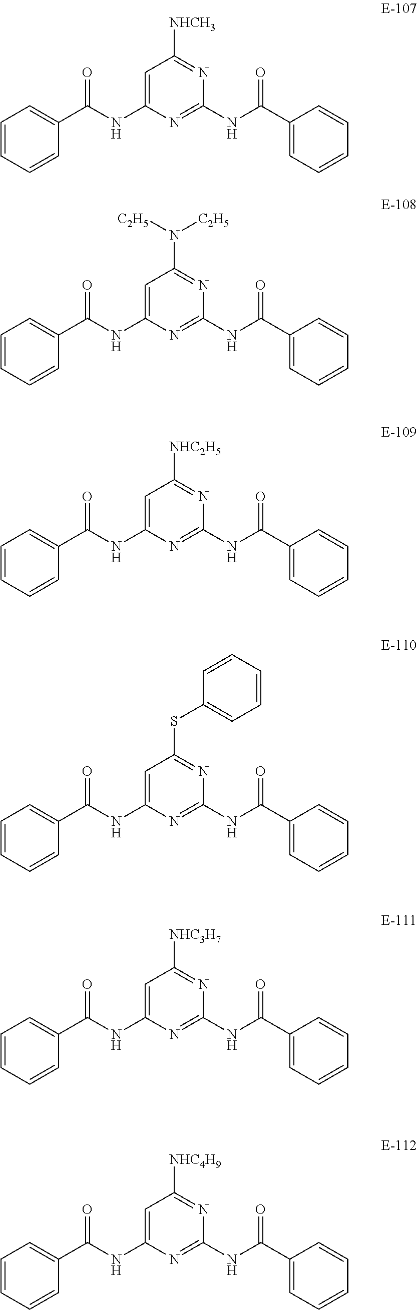

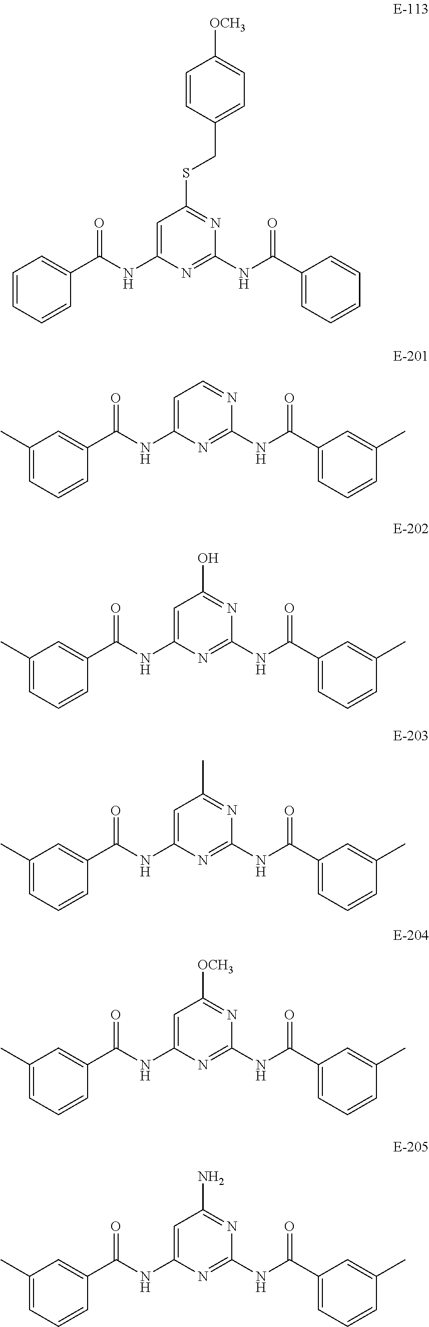

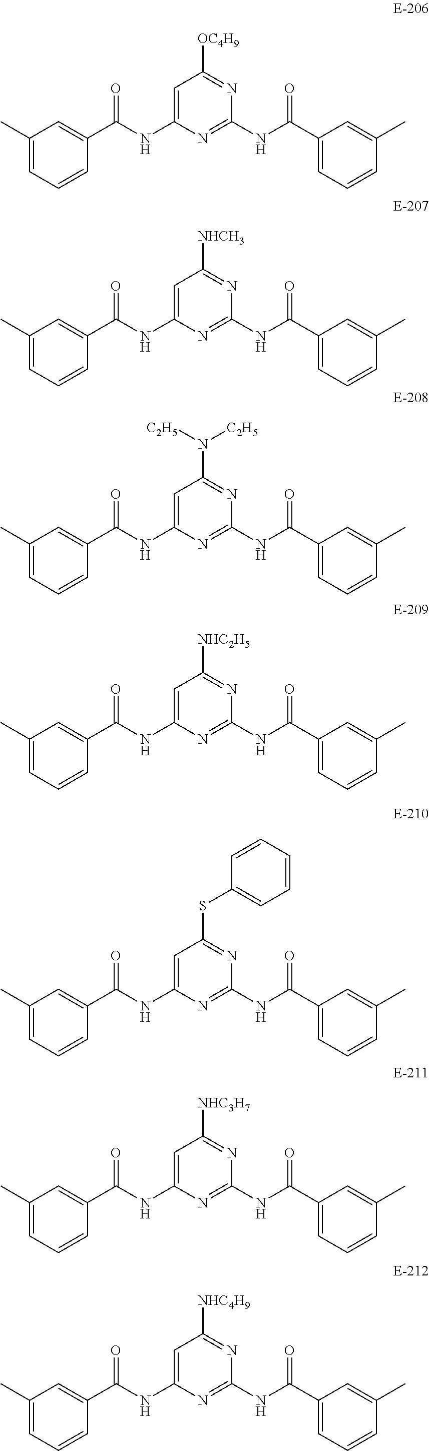

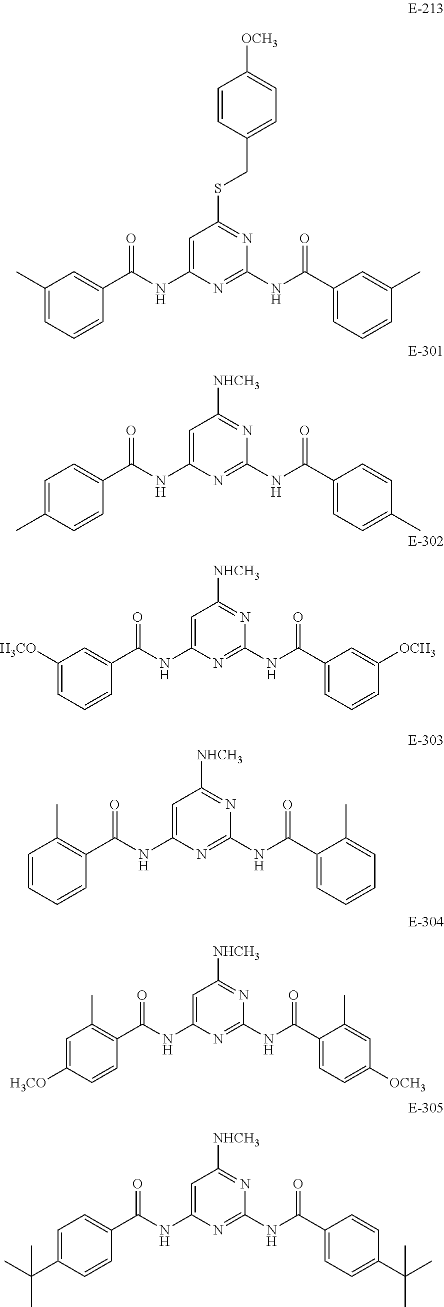

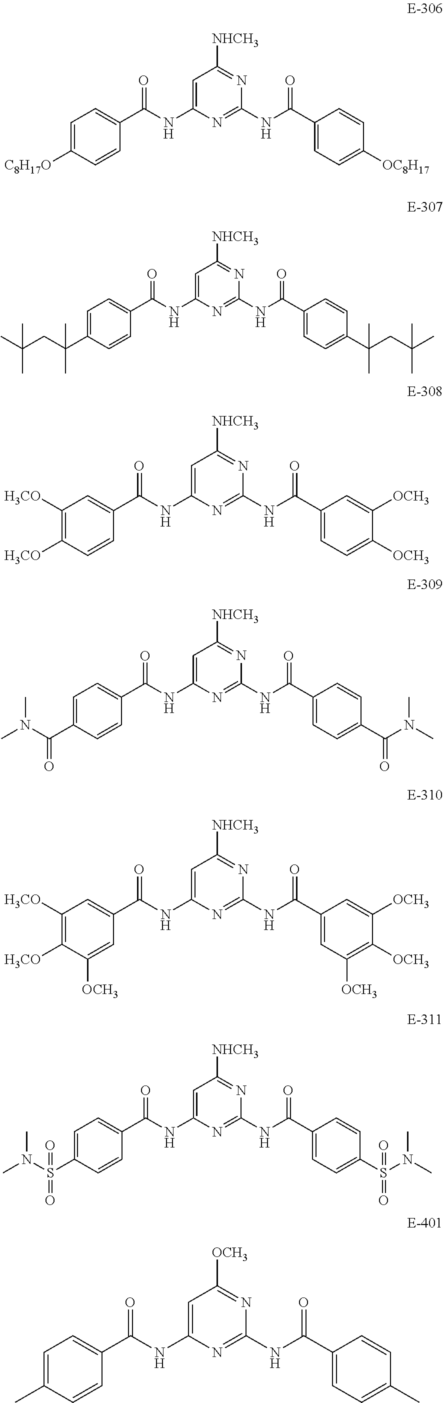

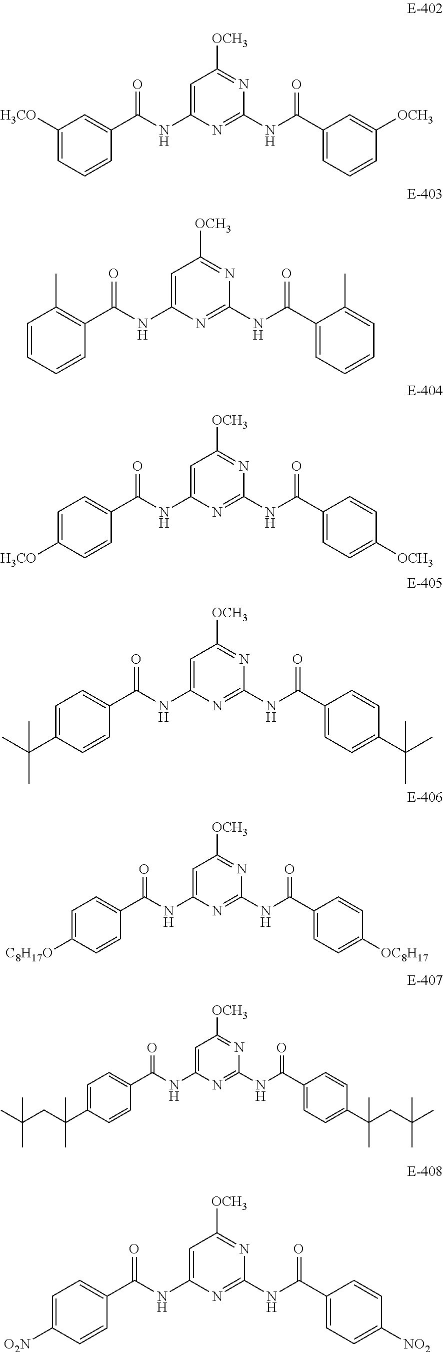

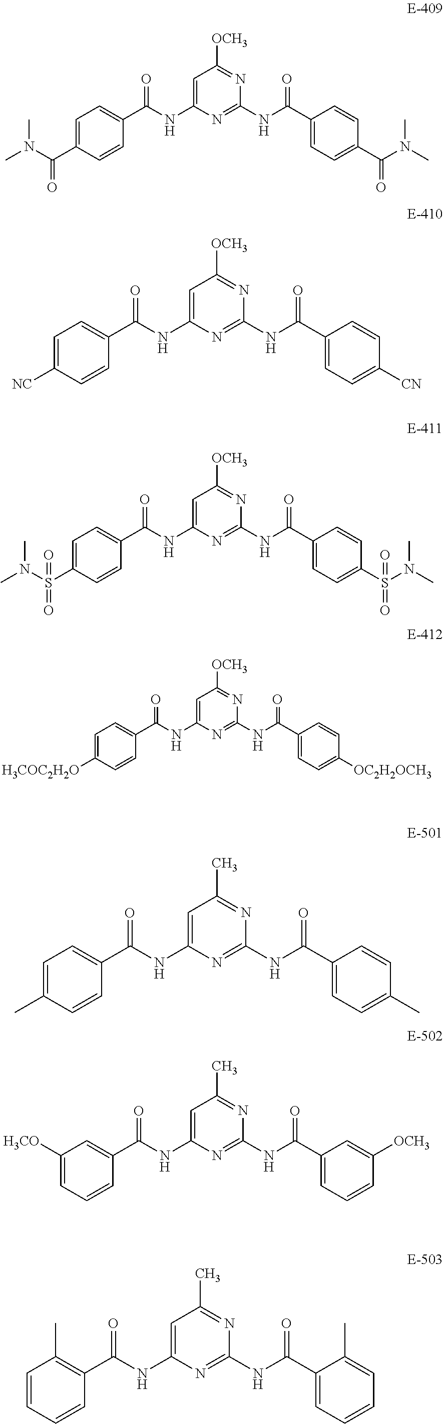

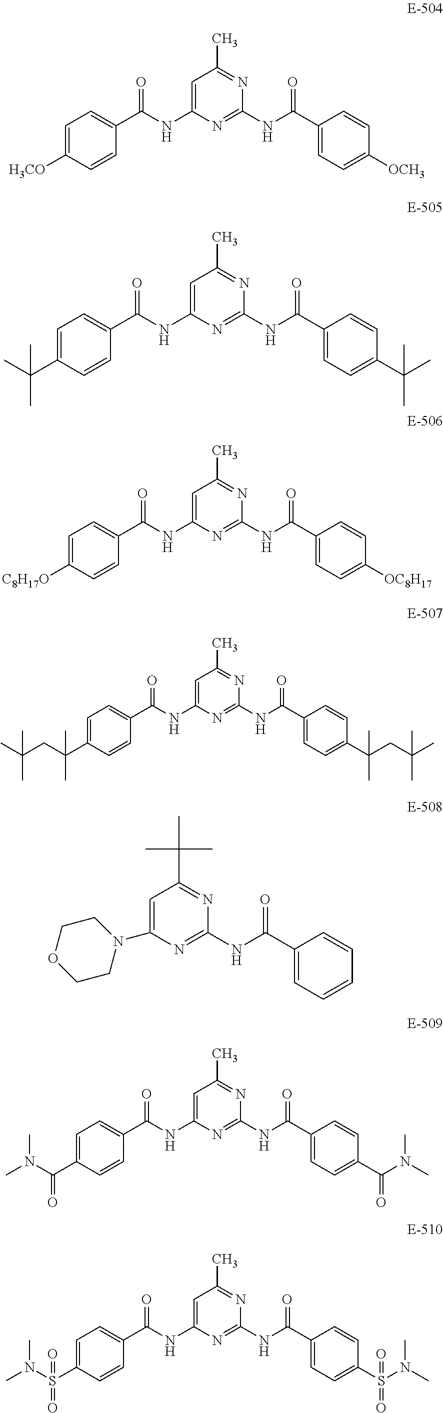

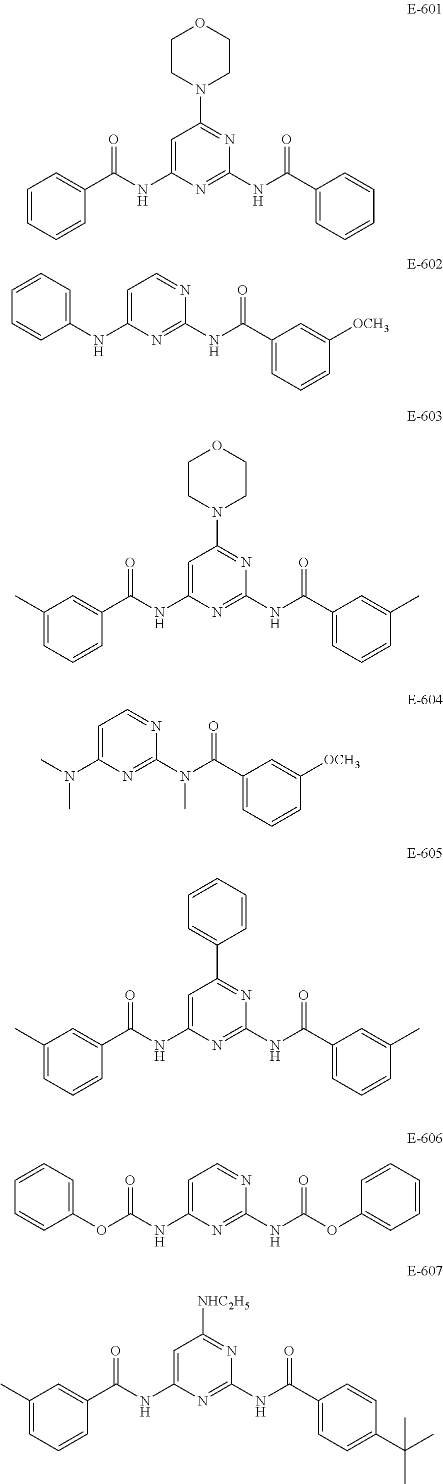

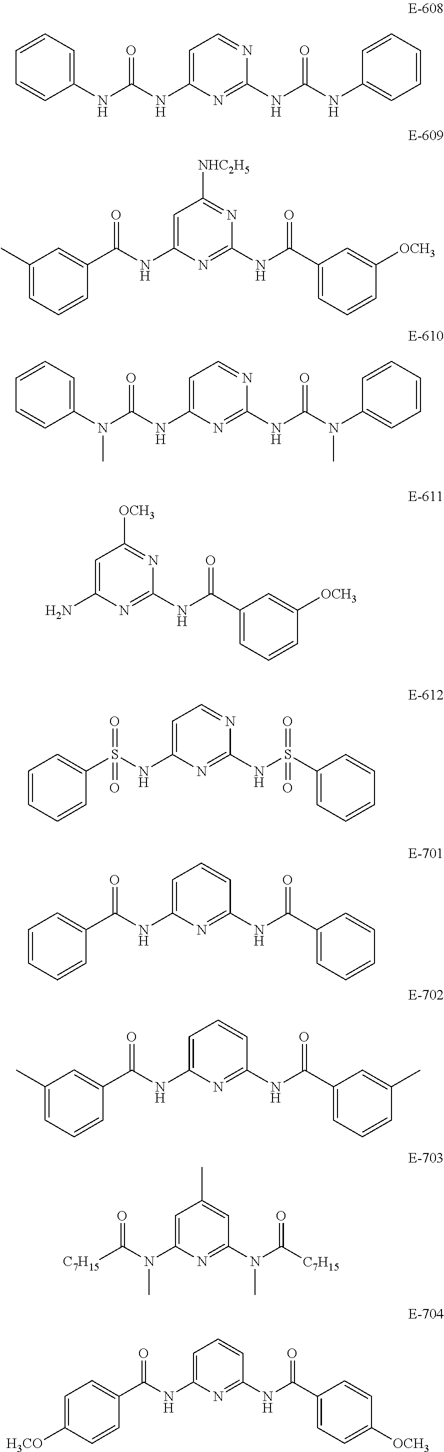

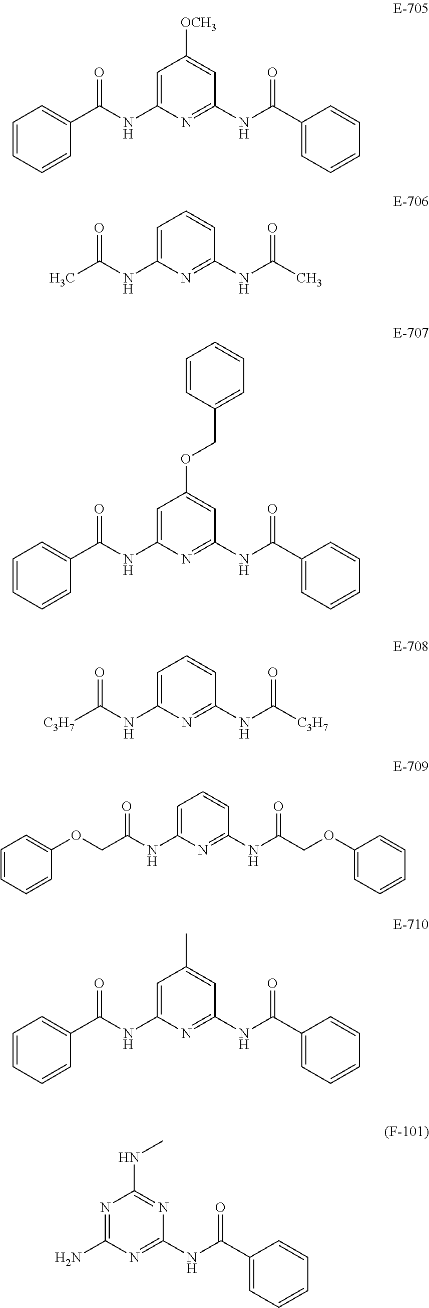

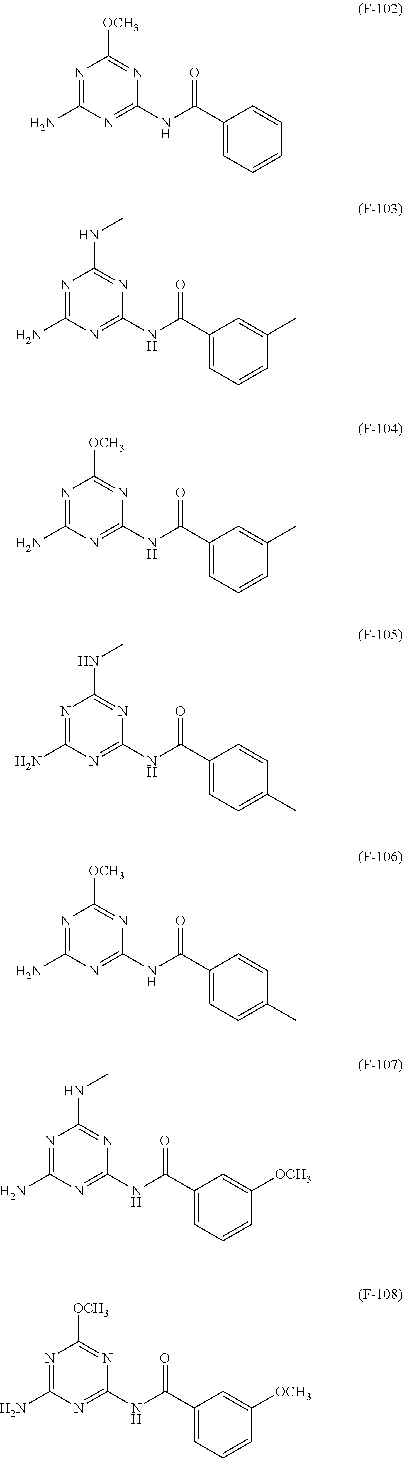

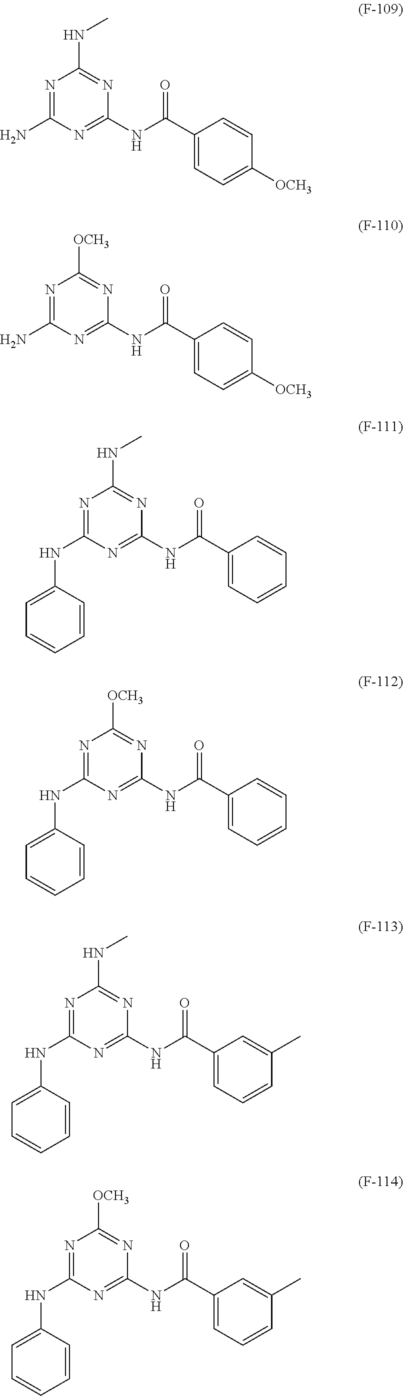

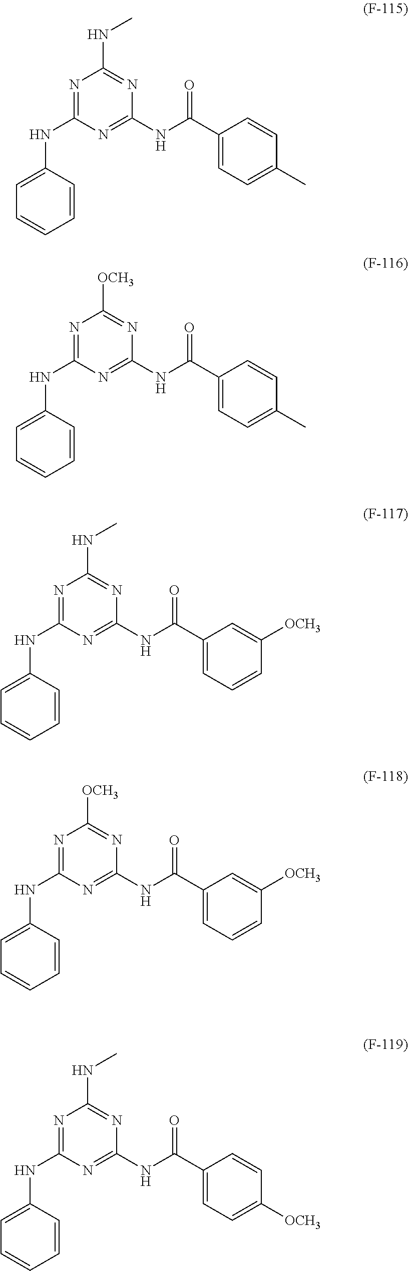

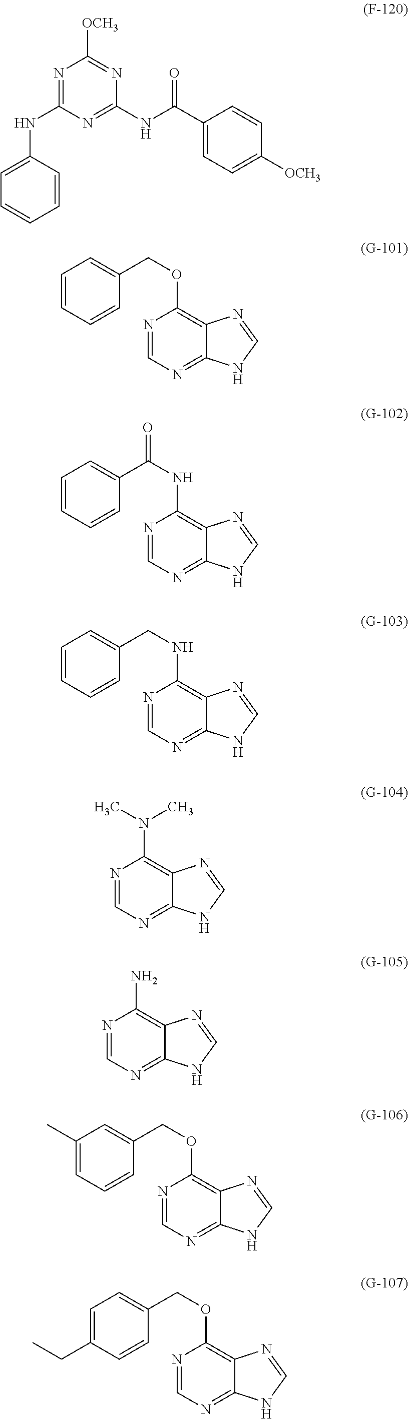

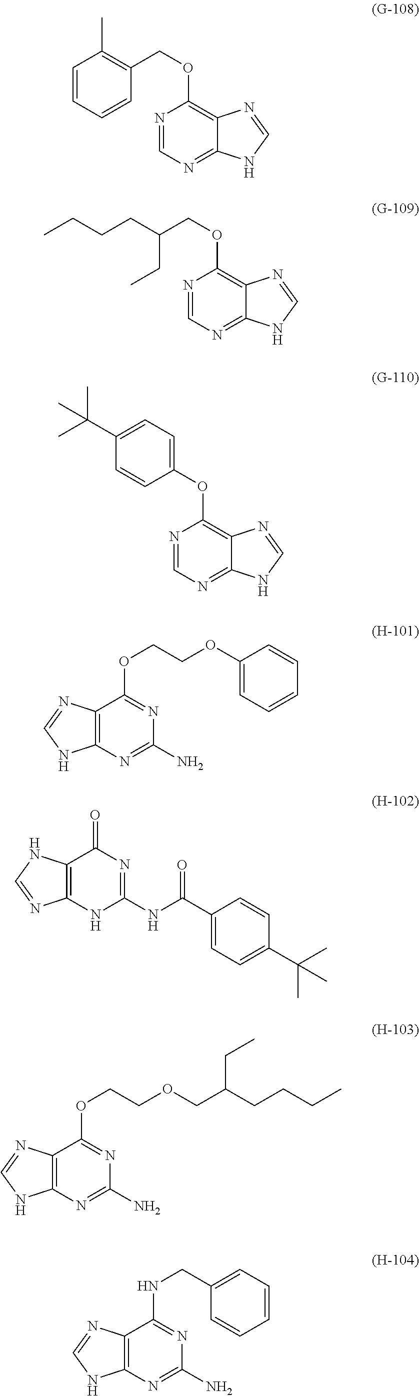

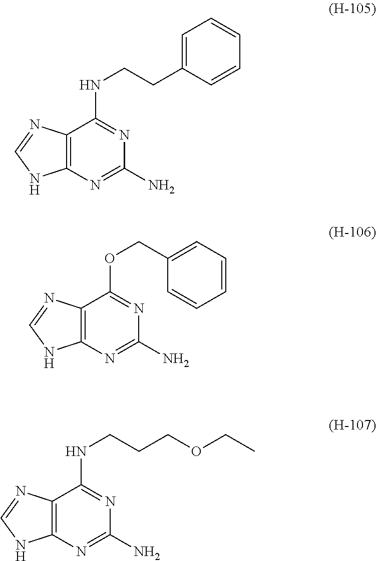

(Physical Properties)

The nitrogen containing aromatic compound has a molecular weight of preferably 100 to 1,000, more preferably 150 to 700, and most preferably 150 to 450.

(Amount of Nitrogen Containing Aromatic Compound Added)

The film of the present invention has a total content of the nitrogen containing aromatic compound preferably in the range of 20% by mass or less, more preferably 15% by mass or less, and particularly preferably 10% by mass or less, based on the total content of the cellulose acylate resin. However, the cellulose acylate film of the present invention includes a plasticizer in an amount of 30% to 65% by mass based on the cellulose acylate, as described above. The nitrogen containing aromatic compounds are not limited to the compounds represented by general formulas (A-1) to (H-107).

[Other Additives]

Besides the plasticizers, various low molecular and high molecular weight additives (for example, degradation inhibitors, Ultraviolet (UV) absorbers, retardation (optical anisotropy) controlling agents, peeling accelerators, other plasticizers, Infrared (IV) absorbers, matting agents, and the like) can be added to the cellulose acylate film of the present invention according to the use in each preparation process, and these may be in the form of solid or oil. That is, the melting point or boiling point thereof is not particularly limited. For example, mixing of UV absorbing materials having melting point of 20° C. or less and having melting point of higher than 20° C., respectively may be carried out, or mixing of degradation inhibitors having such a temperature difference may be carried out. Infrared absorbing dyes are described in, for example, in Japanese Patent Application Laid-Open No. 2001-194522. The addition can be carried out at any time in the manufacturing process of a cellulose acylate solution (dope). However, the addition may be performed by further including a process for adding additives to the final preparation process in the dope preparation process to prepare the dope solution. The amount of each material added is not particularly limited as long as functions are developed.

(Degradation Inhibitors)

It is preferable to use degradation (oxidation) inhibitors which are well known in the art, for example, phenol-based or hydroquinone-based antioxidants, phosphorus-based antioxidants in the cellulose acylate solution of the present invention. The amount of an antioxidant added preferably ranges from 0.05% to 5.0% by mass based on the cellulose acylate.

(UV Absorbers)

In the cellulose acylate solution of the present invention, UV absorbers are preferably used from the viewpoint of degradation inhibition of polarizing plates or liquid crystals. As UV absorbers, it is preferable to use those which are excellent in ability to absorb UV light at a wavelength of 370 nm or less and low in absorption of visible light at a wavelength of 400 nm or more from the viewpoint of excellent liquid crystal display performance. Specific examples of UV absorbers that are preferably used in the present invention may include hindered phenol-based compounds, oxybenzophenone-based compounds, benzotriazole-based compounds, salicylic acid ester-based compounds, benzophenone-based compounds, cyano acrylate-based compounds, nickel complex salt-based compounds, and the like. The amount of the ultraviolet absorber added is preferably 1 ppm to 1.0% by mass, more preferably 10 to 1000 ppm based on the amount of the cellulose acylate.

Specific examples of the UV absorbers include the following UV-1 to UV-3, but, the UV absorber to be added is not limited thereto.

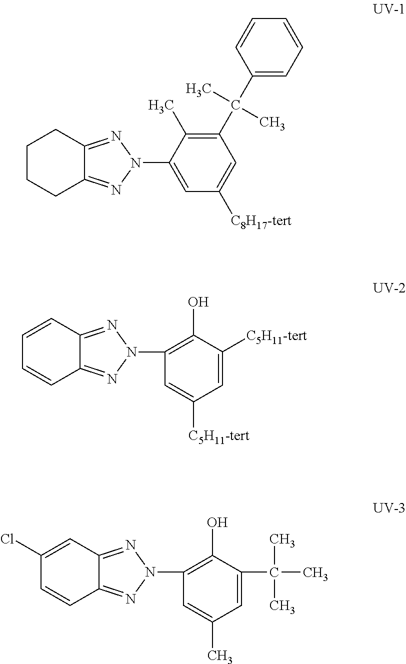

(Retardation Developers)

In order to develop retardation in the present invention, a compound having at least two aromatic rings can be used as a retardation developer.

It is preferable to develop the optically positive uniaxiality when a compound having at least two aromatic rings is uniformly oriented.

The molecular weight of the compound having at least two aromatic rings is preferably 300 to 1,200, and more preferably 400 to 1,000.

When the cellulose acylate film of the present invention is used as an optically-compensatory film, stretching is effective when optical properties, in particular, Re is intended to be controlled to a preferable value. The refractive index anisotropy in the plane of the film needs to be enhanced in order to increase Re, and one method is to improve in the main chain orientation of the polymer film by stretching. It is possible to further increase the refractive index anisotropy of the film by using a compound having large refractive index anisotropy as an additive. For example, a force to allow the main chain of the polymer to be aligned in parallel is transferred to the compound having at least two aromatic rings by stretching to improve the orientation of the compound, and thus it becomes easy to control optical properties to desired properties.

Examples of the compound having at least two aromatic rings may include triazine compounds disclosed in Japanese Patent Application Laid-Open No. 2003-344655, rod-shaped compounds disclosed in Japanese Patent Application Laid-Open No. 2002-363343, and liquid crystalline compounds disclosed in Japanese Patent Application Laid-Open Nos. 2005-134884 and 2007-119737. More preferably, the compound is the triazine compounds or rod-shaped compounds.

Compounds having at least two aromatic rings may be used in combination of two or more kinds thereof.

The amount of the compound having at least two aromatic rings to be added is preferably 0.05% to 10% by mass, more preferably 0.5% to 8% by mass, and even more preferably 1% to 5% by mass, based on the amount of the cellulose acylate.

(Peeling Accelerators)

As additives to decrease the peel resistance of the cellulose acylate film, those having significant effects on surfactants have been discovered in many cases. As preferred peeling agents, phosphoric ester-based surfactants, carboxylic acid- or carboxylate-based surfactants, sulfonic acid- or sulfonate-based surfactants, and ester sulfate-based surfactants are effective. Fluorine-based surfactants are effective, in which a part of hydrogen atoms bound to hydrocarbon chains of the surfactant were substituted with fluorine atoms.

The amount of the peeling agent to be added is preferably 0.05% to 5% by mass, more preferably 0.1% to 2% by mass, and most preferably 0.1% to 0.5% by mass, based on the amount of the cellulose acylate.

(Matting Agent Fine Particles)

The cellulose acylate film of the present invention may contain fine particles as a matting agent. Examples of the fine particles used in the present invention may include silicon dioxide, titanium dioxide, aluminum oxide, zirconium oxide, calcium carbonate, talc, clay, calcined kaolin, calcined calcium silicate, hydrated calcium silicate, aluminum silicate, magnesium silicate and calcium phosphate. The fine particles containing silicon are preferable in that the turbidity is low, and silicon dioxide is particularly preferable. As fine particles of silicon dioxide, those having a primary average particle diameter of 20 nm or less and an apparent specific gravity of 70 g/L or more are preferable. Those having a small average particle size of primary particles as from 5 nm to 16 nm are more preferable in that the haze of the film can be reduced. The apparent specific gravity is preferably 90 to 200 g/L, and more preferably 100 g/L to 200 g/L. A larger apparent specific gravity is preferable in that dispersion with a high concentration can be prepared and thus the haze and the coagulated material are improved. A preferred embodiment is described in detail on pages 35 to 36 of Japan Institute of Invention and Innovation Kokai Giho (Open Technical Report) (Technical Disclosure No. 2001-1745, issued on Mar. 15, 2001, Japan Institute of Invention and Innovation) and can also be preferably used in the cellulose acylate film of the present invention.

[Preparation of Cellulose Acylate Film]

(Film Forming Process)

A method for preparing a cellulose acylate film in the present invention can widely employ any well-known methods for manufacturing a cellulose acylate film, and the film is preferably prepared by a solvent casting method. In the solvent casting method, a film can be prepared by casting a solution (dope) of cellulose acylate dissolved in an organic solvent.

The organic solvent preferably contains a solvent selected from ethers having 3 to 12 carbon atoms, ketones having 3 to 12 carbon atoms, esters having 3 to 12 carbon atoms, and halogenated hydrocarbons having 1 to 6 carbon atoms. The ethers, ketones and esters may have a cyclic structure. Compounds having two or more of functional groups of ether, ketone and ester (that is, —O—, —CO— and COO—) can be also used as an organic solvent. The organic solvent may have other functional groups such as an alcoholic hydroxyl group. In the case of an organic solvent having two or more kinds of functional groups, it is preferable that the number of carbon atoms falls within a defined range of a compound having any one of functional groups.

In the whole solvents to be included in a solution (dope) containing cellulose acylate during solution casting, the ratio of the solvent functioning as a good solvent for cellulose acylate is preferably 79% to 95% by mass, more preferably 82% to 94% by mass, and most preferably 87% to 92% by mass.

During casting on a cooled drum, a poor solvent is needed in a certain ratio for gelation of the dope, and the ratio of the good solvent is preferably from 79% by mass or more to less than 87% by mass, more preferably from 79% by mass or more to less than 85% by mass, and most preferably 79% by mass or more to less than 83% by mass.

During co-casting of a dope for base layer and a dope for surface layer, the ratio of the good solvent in the dope for base layer is preferably from 79% by mass or more to less than 87% by mass, more preferably from 79% by mass or more to less than 85% by mass, and most preferably 79% by mass or more to less than 83% by mass. The ratio of the good solvent in the dope for surface layer is preferably from 83% by mass to less than 95% by mass, more preferably from 85% by mass or more to less than 95% by mass, and most preferably 87% by mass or more to less than 92% by mass.

Examples of the ethers having 3 to 12 carbon atoms include diisopropyl ether, dimethoxy methane, dimethoxy ethane, 1,4-dioxane, 1,3-dioxolan, tetrahydrofuran, anisole and phenetole.

Examples of the ketones having 3 to 12 carbon atoms include acetone, methyl ethyl ketone, diethyl ketone, diisobutyl ketone, cyclohexanone and methylcyclohexanone.

Examples of the esters having 3 to 12 carbon atoms include ethyl formate, propyl formate, pentyl formate, methyl acetate, ethyl acetate and pentyl acetate.

Examples of the organic solvent having two or more kinds of functional groups include 2-ethoxyethyl acetate, 2-methoxy ethanol and 2-butoxy ethanol.

The number of carbon atoms in the halogenated hydrocarbon is preferably 1 or 2, and most preferably 1. The halogen in the halogenated hydrocarbon is preferably chlorine. The ratio of hydrogen atoms in the halogenated hydrocarbon to be substituted by halogens is preferably 25 mol % to 75 mol %, more preferably 30 mol % to 70 mol %, even more preferably 35 mol % to 65 mol %, and most preferably 40 mol % to 60 mol %. Methylene chloride (dichloromethane) is a representative halogenated hydrocarbon.

The organic solvent may be used in a mixture of two or more kinds thereof.

The good solvent for cellulose acylate refers to a solvent in which cellulose acylate is dissolved in a concentration of 10% by mass or more at room temperature (20° C.), and may include, for example, methylene chloride, chloroform, acetone, methyl acetate, and the like. The poor solvent refers to a solvent in which cellulose acylate is dissolved in a concentration of less than 10% by mass at room temperature, and may include, for example, methanol, ethanol, butanol, and the like.

A cellulose acylate solution can be prepared by a general method. The general method refers to a treatment at a temperature of 0° C. or more (ambient temperature or high temperature). The preparation of the solution can be performed by using a method and an apparatus for preparing a dope in a typical solvent casting method. In the case of the general method, it is preferable to use a halogenated hydrocarbon (in particular, methylene chloride) as an organic solvent.

The amount of cellulose acylate is adjusted such that cellulose acylate is included in an amount of 10% to 40% by mass based on the amount of a solution to be obtained. The amount of cellulose acylate is more preferably 10% to 30% by mass. Any additives as previously described may be added in the organic solvent (main solvent).

The solution can be prepared by stirring the cellulose acylate and the organic solvent at an ambient temperature (from 0° C. to 40° C.). The high-concentration solution may be stirred under pressure and heating conditions. Specifically, the cellulose acylate and the organic solvent are put in a pressure vessel and hermetically sealed, and followed by stirring under pressure while heating at a temperature of the boiling point or higher of the solvent at room temperature, or at a temperature within the range where the solvent does not boil. The heating temperature is usually 40° C. or higher, preferably from 60° C. to 200° C., and more preferably from 80° C. to 110° C.

Each component may be coarsely mixed in advance, and then put in the vessel. The components may be successively charged in the vessel. It is necessary that the vessel is configured such that stirring can be achieved. The vessel can be pressurized by injecting an inert gas such as a nitrogen gas. A rise in the vapor pressure of the solvent due to heating may be utilized. Alternatively, each component may be added under pressure after hermetically sealing the vessel.

In the case of heating, it is preferable that heating is carried out from the outside of the vessel. For example, a jacket type heating apparatus can be used. The whole vessel can be heated by installing a plate heater on the outside of the vessel and laying a pipe to circulate a liquid therein.

It is preferred to provide a stirring blade in the vessel to carry out a stirring operation. The stirring blade has preferably a length so as to reach the vicinity of a wall of the vessel. It is preferable that a scraping blade is provided at the terminal of the stirring blade for the purpose of renewing a liquid film of the wall of the vessel.

Measuring instruments such as a pressure gauge, a thermometer, and the like may be installed in the vessel. In the vessel, each component is dissolved in a solvent. The prepared dope is cooled and then taken out from the vessel, or taken out from the vessel and then cooled by using a heat exchanger or the like.

The cellulose acylate film can be manufactured from the prepared cellulose acylate solution (dope) by a solvent casting process.

The dope is cast on a drum or a band, and the solvent is vaporized to form a film. It is preferable that the dope before casting is adjusted so as to have a concentration in the range of 18% to 35% by mass in terms of solids content. It is preferable that the surface of the drum or band is mirror-finished. The casting and drying method in the solvent casting process is described in U.S. Pat. Nos. 2,336,310, 2,367,603, 2,492,078, 2,492,977, 2,492,978, 2,607,704, 2,739,069 and 2,739,070, British Patent Nos. 640,731 and 736,892, and in Japanese Patent Publication Nos. Sho 45-4554 and Sho 49-5614, and Japanese Patent Application Laid-Open Nos. Sho 60-176834, Sho 60-203430 and Sho 62-115035.

In the solution casting, it is preferred that a solution including cellulose acylate is cast on a metal support (drum or band) cooled to a temperature of 10° C. or lower to form a film. Because casting can be performed on the metal support cooled to a temperature of 10° C. or lower to promote the gelation of the dope, peeling-off can be performed on a drum, and drying can be rapidly performed on both the surfaces, which is preferable in forming the film. The cooling temperature is preferably −20° C. to 0° C., and more preferably −15° C. to 15° C.

It is preferred to blow-dry the dope for 2 sec or more after the casting is performed. The obtained film is peeled off from the drum or band and further dried by high-temperature air while successively changing the temperature from 100° C. to 160° C., whereby a residual solvent can be evaporated. The above-mentioned method is disclosed in Japanese Patent Publication No. Hei 5-17844. According to this method, it is possible to shorten the time from casting to peeling-off. In order to carry out this method, it is necessary that the dope is gelled at the surface temperature of the drum or band during casting.

(Co-Casting)

It is preferred that a film is formed by a solution casting film-forming method, and then stretched to manufacture the cellulose acylate film of the present invention. It is preferred that a plurality of dopes are simultaneously or sequentially co-cast to form a film of multiple layers. It is because a film with a desired retardation value can be manufactured.

In the present invention, when a cellulose acylate film of a double layer structure is formed by co-casting, a layer adjacent to the metal support is a base layer and a layer formed on the base layer is a surface layer. In the case of a cellulose acylate film of multiple layers, such as triple layers or more, a layer adjacent to the metal support and the outermost surface layer of a side (air side) opposite to the layer are surface layers, and at least one of layers lying between the two surface layers is a base layer.

The cellulose acylate solution obtained in the present invention may be cast as a single-layer solution on a smooth band or drum as a metal support, and a plurality of cellulose acylate solutions for double layers or more may be cast. When the plurality of cellulose acylate solutions are cast, a film may be manufactured by casting each of solutions including cellulose acylate from a plurality of casting nozzles prepared at intervals in the progressing direction of a metal support and then stacking cellulose acylate solutions, and methods, described in Japanese Patent Application Laid-Open Nos. Sho 61-158414, Hei 1-122419 and Hei 11-198285, can be adopted. A cellulose acylate solution from two casting nozzles may be cast to form a film, and for example, the casting may be performed by methods described in Japanese Patent Publication No. Sho 60-27562, and Japanese Patent Application Laid-Open Nos. Sho 61-94724, Sho 61-947245, Sho 61-104813, Sho 61-158413 and Hei 6-134933. A cellulose acylate film casting method described in Japanese Patent Application Laid-Open No. Sho 56-162617 may be used, which includes: covering the stream of a high-viscosity cellulose acylate solution with a low-viscosity cellulose acylate solution; and simultaneously extruding the high/low viscosity cellulose acylate solution. It is also one of preferred aspects that an external solution contains alcoholic components as poor solvents in larger amounts than an internal solution, as described in Japanese Patent Application Laid-Open No. Sho 61-94724.

A film may be manufactured by using two casting nozzles to peel off a film formed on a metal support by a first casting nozzle and subjecting the side of the film coming into contact with the surface of the metal support to second casting, and for example a method described in Japanese Patent Publication No. Sho 44-20235 may be used. The cellulose acylate solutions to be cast may be the same as or different from each other, and are not particularly limited. In order to allow a plurality of cellulose acylate layers to have functions, cellulose acylate solutions corresponding to the respective functions may be extruded from the respective casting nozzle. The cellulose acylate solution of the present invention can be cast simultaneously with another functional layer (for example, an adhesion layer, a dye layer, an antistatic layer, an anti-halation layer, an ultraviolet ray absorbing layer, a polarizing layer, and the like).

In a conventional single-layer solution, in order to manufacture a film with a desired thickness, it is necessary to extrude a high-viscosity cellulose acylate solution at a high concentration. In this case, there was often a problem that the stability of the cellulose acylate solution is so poor that solids are generated, thereby causing a breakdown or inferiority in planarity. As a solution to this, by casting a plurality of cellulose acylate solutions from casting nozzles, high-viscosity solutions can be extruded onto the metal support at the same time, and thus a film having improved planarity and excellent surface state can be manufactured. By using concentrated cellulose acylate solutions, a reduction in drying load can be achieved, and thus the production speed of the film can be enhanced.

In the case of co-casting, thicknesses of inner and outer sides are not particularly limited. However, the thickness of the external side is preferably 1% to 50% based on the thickness of the whole film, and more preferably 2% to 30%. Here, in the case of co-casting of 3 layers or more, the total film thickness of a layer adjacent to the metal support and a layer adjacent to air side is defined as a thickness on the outer side.

In the case of co-casting, a cellulose acylate film with a stacked structure can be also manufactured by co-casting cellulose acylate solutions with different degrees of substitution. For example, it is possible to manufacture a cellulose acylate film having a configuration such as TAC (triacetyl cellulose) layer/DAC (diacetyl cellulose) layer/TAC layer and to manufacture a cellulose acylate film having a configuration such as DAC layer/TAC layer/DAC layer.

A cellulose acylate film having a stacked structure can be also manufactured by co-casting cellulose acylate solutions having different solutions of the additives, such as the plasticizers, the UV absorbers, the matting agents, and the like as described above. For example, the matting agent can be put in a larger amount into the surface layer, or only into the surface layer. The plasticizer and the UV absorber may be put in larger amounts into an inner layer (including the base layer) than into the surface layer, and only into the inner layer. The kinds of the plasticizer and the UV absorber in the inner surface and the surface layers can be changed, and for example, a low-volatility plasticizer and/or an UV absorber can be included in the surface layer, and a plasticizer with excellent plasticity or an UV absorber with excellent UV absorption may be added to the inner layer. It is a preferred aspect that a peeling agent is included only into the surface layer at the metal support.

In order to cool the metal support by a cooling drum method for gelation of the solution, it is also preferred that alcohol as a poor solvent is added in a larger amount to the surface layer than to the inner layer. T_{g} of the surface layer may be different from that of the inner layer.

The viscosity of the solution containing the cellulose acylate upon casting may be different in the surface layer and the base layer, and the viscosity of the surface layer is preferably smaller than that of the inner layer. However, the viscosity of the inner layer may be smaller than that of the surface layer.

(Drying Process and Stretching Process)

A drying method of a web, which is dried on a drum or belt and peeled off, will be described. A web, which is peeled off at a peeling position immediately before a drum or belt goes on a round, is conveyed by a conveying method which allows the web to pass alternately through a group of rolls disposed in a zig-zag pattern, or by a conveying method which allows the peeled web to be nipped by means of a clip and the like at both edges thereof and conveyed in a non-contact way. Drying is carried out by blow-drying both sides of the web (film) while being conveyed at a predetermined temperature or by a heating means such as a microwave oven, and the like. Rapid drying may damage the planarity of a film to be formed, and thus it is preferred that the film is dried at a temperature where bubbles are not produced from the solvent at the early stage of drying, drying is progressed to some degrees, and then the film is dried at a high temperature. In the drying process after peeling-off from the support, the film is apt to shrink in a length or width direction by evaporation of the solvent. The shrinkage increases as drying is performed at higher temperatures. It is preferred that the planarity of the manufactured film is improved if the film is dried while the shrinkage is being suppressed as much as possible. In this regard, as disclosed, for example, in Japanese Patent Application Laid-Open No. Sho 62-46625, it is preferable to perform the whole or part of the drying process in a width direction while the width between both edges of the web is maintained by means of a clip or pin (tenter type). In the drying process, the drying temperature is preferably 100° C. to 145° C. The drying temperature, drying air flow and drying time vary depending on the solvent to be used, but may be appropriately selected according to the kind and combination of solvents to be used. In the manufacture of the film of the present invention, it is preferable to stretch the web (film) peeled from the support when the residual solvent amount is less than 120% by mass based on the web.

The residual solvent amount may be represented by the following formula.

Residual solvent amount (% by mass)={(M−N)/N}×100

Where M represents a mass at any time point of the web and N represents a mass when a web with M measured is dried at 110° C. for 3 hours. If the residual solvent amount in the web is excessively high, it is impossible to obtain stretching effects, while when the amount is excessively low, it becomes significantly difficult to perform stretching, and thus the web may break. The residual solvent amount in the web is more preferably 70% by mass or less, more preferably 10% to 50% by mass, and particularly preferably 12% to 35% by mass. When the stretching magnification is excessively low, it is impossible to obtain a sufficient phase difference, while when the stretching magnification is excessively high, it becomes significantly difficult to perform stretching, and thus the web may break.

The stretching magnification is preferably 1.05 to 1.5, and more preferably 1.15 to 1.4.

Stretching may be performed in a longitudinal or transverse direction, or in both directions, and preferably at least in a longitudinal direction. The cellulose acylate film of the present invention is obtained while being stretched in a width direction, and the stretching magnification thereof is preferably 5% to 100% with respect to a direction which is vertical to the conveying direction. Re can be developed more appropriately by keeping the stretching magnification at 5% or more, and thus Boeing can be improved. The haze can be reduced by keeping the stretching magnification at 50% or less. For details of stretching, reference can be made to Japanese Patent Application Laid-Open No. 2010-250298.

(Heat Treatment Process)

The method for manufacturing the film of the present invention preferably includes a heat treatment process after the completion of drying process. Heat treatment in the heat treatment process may be performed after the completion of the drying process, and may be performed immediately after the stretching/drying process. Alternatively, after the completion of the drying process, winding is performed in a manner as described below, and then only a separate heat treatment may be performed. In the present invention, it is preferred that cooling is performed from room temperature to 100° C. and then the heat treatment is again performed, after the completion of the drying process. This is advantageous in that a film which is excellent in terms of thermal dimensional stability can be obtained. For the same reason, it is preferred that the residual solvent amount immediately before the heat treatment process is dried to an amount of less than 2% by mass and preferably less than 0.4% by mass.

It is not clearly understood why the shrinkage rate of the film can be reduced by this treatment. However, it is estimated that because the residual stress in a stretching direction is high in the film subjected to stretching treatment in the stretching process, the residual stress can be resolved by heat treatment and thus the shrinkage force is reduced in a region at the heat treatment temperature or lower.

Heat treatment is carried out by blow-drying the film while being conveyed at a predetermined temperature or by a heating means such as a microwave oven, and the like.

The heat treatment is preferably performed at a temperature of 150° C. to 200° C., and more preferably at a temperature of 160° C. to 180° C. The heat treatment is preferably performed for 1 min to 20 min, and more preferably for 5 min to 10 min.

If the heat treatment is performed at a temperature of more than 200° C. for a prolonged period of time, the amount of plasticizers scattered, which are contained in the film, is increased and thus a problem may occur.

In the heat treatment process, the film is apt to shrink in a length or width direction. It is preferred that the film is subjected to heat treatment while the shrinkage is being suppressed as much as possible so as to improve the planarity of the manufactured film, and it is preferable to perform the heat treatment while the width between both edges of the web is maintained by means of a clip or pin (tenter type). It is preferable to stretch 0.9 times to 1.5 times in width and conveying directions of the film, respectively.

The film obtained can be wound by a winding machine commonly employed, and can be wound according to a winding method, such as a constant tension method, a constant torque method, a taper tension method, and a program tension control method of constant internal stress. In an optical film roll thus obtained, the slow axis direction of the film is preferably ±2° with respect to the winding direction (length direction of the film), and more preferably ±1°. Alternately, the direction is preferably ±2° with respect to the direction perpendicular to the winding direction (width direction of the film), and more preferably within ±1°. In particular, the slow direction of the film is preferably within ±0.1° with respect to the winding direction (length direction of the film). Otherwise, the direction is preferably within ±0.1° with respect to width and length directions of the film.

[Heated Water Vapor Treatment]

The film subjected to stretching treatment may be then manufactured through a process of spraying water vapor heated to 100° C. or more. It is preferred that the residual stress of the cellulose acylate film manufactured through the water vapor spraying process is alleviated and the dimensional change is reduced. The temperature of water vapor is not particularly limited as long as it is 100° C. or higher. However, considering the heat resistance of the film, the temperature of water vapor should be 200° C. or lower.

The processes from casting to post-drying may be performed under air atmosphere or under inert air atmosphere, such as nitrogen gas. The winding machine used for manufacture of the cellulose acylate film of the present invention may be the one which is commonly employed, and the film can be wound according to a winding method, such as a constant tension method, a constant torque method, a taper tension method, and a program tension control method of constant internal stress.

[Surface Treatment of Cellulose Acylate Film]

It is preferable to perform a surface treatment on the cellulose acylate film. Specific methods of the surface treatment may include corona discharge treatment, glow discharge treatment, flame treatment, acid treatment, alkali treatment, or UV ray irradiation treatment. As described in Japanese Patent Application Laid-Open No. Hei 7-333433, it is preferable to include an undercoat layer.

From the viewpoint of maintaining the planarity of the film, it is preferable to maintain the temperature of the cellulose acylate film at Tg (glass transition temperature) or lower in those treatments, and specifically 150° C. or lower.

When the film is used as a transparent protective film for a polarizing plate, it is particularly preferable to perform an acid treatment or an alkali treatment, that is, a saponification treatment for cellulose acylate from the viewpoint of adhesion with a polarizer.

The surface energy is preferably 55 mN/m or more, and more preferably 60 mN/m to 75 mN/m.

For saponification treatment and surface energy, reference can be made to the description in Japanese Patent Application Laid-Open No. 2010-79241 or the like.

(Film Thickness)

A film thickness of the cellulose acylate film of the present invention is preferably from 20 to 180 μm, more preferably from 20 μm to 100 μm, and even more preferably from 20 μm to 80 μm. When the film thickness is 20 μm or more, it is preferable in view of handling properties during processing into a polarizing plate or the like and curl suppression of a polarizing plate. Unevenness in film thickness of the cellulose acylate film of the present invention is preferably from 0% to 2%, more preferably from 0% to 1.5%, and particularly preferably from 0% to 1% in any of the conveying direction and the width direction.

(Retardation of Film)

In the present specification, Re (λ) and Rth (λ) represent an in-plane retardation and a retardation in a thickness-direction at a wavelength of λ, respectively. Re is measured by irradiating with an incident light of λ nm in wavelength in the normal direction of the film using KOBRA 21ADH (manufactured by Oji Scientific Instruments Co., Ltd.). Rth is calculated based on a sum of the Re, a retardation value measured by irradiating with an incident light of λ nm in wavelength in the direction inclined at an angle of +40° with respect to a direction of the normal line of the film with taking the slow axis in plane (determined by KOBRA 21ADH) as an inclination axis (rotation axis), and a retardation value measured by irradiating with an incident light of λ nm in wavelength in the direction inclined at an angle of −40° with respect to a direction of the normal line of the film with taking the slow axis in plane as an inclination axis (rotation axis), and the retardation values measured in 3 directions, by using KOBRA 21 ADH. Here, as the assumed value of average refractive index, values described in a polymer handbook (John Wiley & Sons, Inc.) and catalogues of various optical films can be used. For films whose average refractive index is unknown, the average refractive index can be measured by using an Abbe's refractometer. Values of average refractive index of main films are exemplified below. The values of average refractive index of cellulose acylate, cycloolefin polymer, polycarbonate, polymethyl methacrylate and polystyrene are 1.48, 1.52, 1.59, 1.49, and 1.59, respectively. nₓ, n_{y} and n_{z} are calculated by inputting the assumed average values of refractive index and the thickness into KOBRA 21ADH. N_{z}=(nₓ−n_{z})/(nₓ−n_{y}) is further calculated from the thus calculated nₓ, n_{y} and n_{z}.

The cellulose acylate film of the present invention can be preferably used as a protective film for a polarizing plate. The cellulose acylate film of the present invention can be also used as a film having no phase difference. In this case, Re measured at 590 nm is preferably −10 nm to 10 nm, more preferably −5 nm to 5 nm, and even more preferably −3 nm to 3 nm. Rth is preferably −20 nm to 20 μm, more preferably −10 nm to 10 nm, and even more preferably −5 nm to 5 nm. A cellulose acylate film having these optical properties is preferable, for example, for IPS mode.

The film may be preferably used as a phase difference film corresponding to various liquid crystal modes. The phase difference film of the present invention includes the cellulose acylate film of the present invention.

When the cellulose acylate film of the present invention is used as the phase difference film, Re measured at 590 nm is preferably 30 nm to 200 nm, more preferably 30 nm to 150 nm, and even more preferably 40 nm to 100 nm. Rth is preferably 70 nm to 400 nm, more preferably 100 nm to 300 nm, and even more preferably 100 nm to 250 nm.

More preferable optical properties of the cellulose acylate film vary depending on liquid crystal modes.

For a VA mode, Re measured at 590 nm is preferably 30 nm to 200 nm, more preferably 30 nm to 150 nm, and even more preferably 40 nm to 100 nm. Rth is preferably 70 nm to 400 nm, more preferably 100 nm to 300 nm, and even more preferably 100 nm to 250 nm.

For a TN mode, Re measured at 590 nm is preferably 0 to 100 nm, more preferably 20 nm to 90 nm, and even more preferably 50 nm to 80 nm. Rth is preferably 20 nm to 200 nm, more preferably 30 nm to 150 nm, and even more preferably 40 nm to 120 nm.

In the TN mode, a film obtained by applying an optically anisotropic layer on the cellulose acylate film having the retardation values can be used as an optically-compensatory film.

(Haze of Film)

The haze of the cellulose acylate film of the present invention is preferably 0.01% to 2.0% from the viewpoint of transparency. The haze is more preferably 0.05% to 1.5%, and even more preferably 0.1% to 1.0%. Measurement of the haze can be conducted in accordance with JIS K-6714 by using a haze meter “HGM-2DP” manufactured by Suga Test Instruments Co., Ltd.

(Spectroscopic Characteristics, Spectral Transmissivity)

Transmissivity can be measured at a wavelength of 300 nm to 450 nm at 25° C. and 60% RH with a spectrophotometer “U-3210” (Hitachi Ltd.) by preparing a 13 mm×40 mm sample of a cellulose acylate film. The inclination width can be obtained with a 72% wavelength to a 5% wavelength. The threshold wavelength can be represented by (inclination width/2)+5% wavelength, and absorption edge can be represented by a wavelength with 0.4% transmissivity. Transmissivities at 380 nm and 350 nm can be evaluated from this.

When the cellulose acylate film of the present invention is used at a side facing a protective film adjacent to a liquid crystal cell of a polarizing plate, it is preferred that the spectral transmissivity measured at the wavelength of 380 nm is 45% to 95%, and the spectral transmissivity measured at the wavelength of 350 nm is 10% or less.

(Glass Transition Temperature)

The glass transition temperature of the cellulose acylate film of the present invention is preferably 120° C. or higher, and more preferably 140° C. or higher.

The glass transition temperature can be determined by using a differential scanning calorimeter (DSC) as an average value of a temperature at which a base line derived from glass transition of a film when measured at a heating rate of 10° C./min starts to be modified and a temperature at which the glass goes back to the base line when measured at a heating rate of 10° C./min.

Measurement of the glass transition temperature can be conducted by using the following dynamic viscoelasticity measuring device. A 5 mm×30 mm sample (not stretched) of the cellulose acylate film of the present invention is humidity controlled at 25° C. and 60% RH for at least 2 hours. Measurement is made with a dynamic viscoelasticity measuring device (Vibron: DVA-225 (manufactured by ITK Co., Ltd) at a distance between grips of 20 mm, at a heating rate of 2° C./min, at a measuring temperature range from 30° C. to 250° C., and at a frequency of 1 Hz. When the storage modulus is plotted on a logarithmic ordinate and the temperature (° C.) is plotted on a linear abscissa at the horizontal axis, a straight line 1 and a straight line 2 showing a steep decrease in storage modulus observed at the phase transition from the solid region to the glass transition region are drawn in the solid region and the glass transition region, respectively. The intersection of the lines 1 and 2 indicates the temperature at which the storage modulus starts to decrease abruptly and the film starts to soften during heating, i.e., at which the film begins to be transferred to the glass transition region. Therefore, this temperature is referred to as the glass transition temperature Tg (dynamic viscoelasticity).

(Equilibrium Water Content of Film)

For use as a protective film for a polarizing plate, it is preferred for the cellulose acylate film of the present invention to have an equilibrium water content of 0% to 4% at 25° C. and 80% RH irrespective of the film thickness so as not to impair the adhesion with a water soluble polymer such as polyvinyl alcohol, and the like. The water content is more preferably 0.1% to 3.5% and particularly preferably 1% to 3%. With the equilibrium water content of 4% or less, the film is prevented from having too much humidity dependence of retardation, which is advantageous for use as a support of an optically-compensatory film.

The water content is measured by a Karl-Fischer's method on a sample 7 mm×35 mm of the cellulose acylate film of the present invention using a moisture meter CA-03 and a sample drying device VA-05, (both of which manufactured by Mitsubishi Chemical Corp.). The measured amount of water (g) is divided by the sample mass (g) to give a water content.

(Moisture Permeability of Film)

The moisture permeability of a film can be measured under conditions of 60° C. and 95% RH in accordance with JIS Z-0208.

The moisture permeability decreases with an increase in film thickness of the cellulose acylate film, and increases with a decrease in film thickness. Thus, samples with different film thicknesses need to be normalized to a reference of 80 μm. The normalization of film thickness can be carried out according to the following Equation.

Moisture permeability normalized to 80 μm=measured moisture permeability×measured film thickness (μm)/80 (μm) Equation:

For measurement of moisture permeability, the method described in “Properties of Polymers II” (Lecture on Polymer Experiment 4, Kyoritsu Shuppan Co., Ltd.), pp. 285-294 “Measurement of vapor permeability (Mass method, Thermometer method, Vapor pressure method, Adsorption amount method)” can be used.

The cellulose acylate film of the present invention preferably has the moisture permeability of 500 g/m²·24 h to 4,000 g/m²·24 h. The moisture permeability is more preferably 1,000 g/m²·24 h to 3,000 g/m²·24 h and particularly preferably 1,500 g/m²·24 h to 2,500 g/m²·24 h. When the moisture permeability is 2,500 g/m²·24 h or less, a problem that the absolute value of humidity dependence of the Re and Rth of the film exceeds 0.5 nm % RH can be avoided, which is preferable.

(Dimensional Change of Film)

The cellulose acylate film of the present invention preferably has dimensional stability such that the dimensional changes occurring when the film is left to stand at 60° C. and 90% RH for 24 hours (high humidity condition) and when the film is left to stand at 90° C. and 5% RH for 24 hours (high temperature condition) are both 0.5% or less.

The dimensional changes are more preferably 0.3% or less, and even more preferably 0.15% or less.

(Elastic Modulus of Film)

The elastic modulus of the cellulose acylate film of the present invention is preferably 1.0 Gpa or more from the viewpoint of conveyability during forming the film. As a specific measuring method, the stress can be measured using a universal tensile tester “STM T50BP” manufactured by Toyo Baldwin Co., Ltd. to determine the elastic modulus when the sample is stretched by 0.5% under the conditions of 25° C., 60 RH %, and stretching rate of 10%/min.

In this case, a cellulose acylate film with a distribution in a thickness direction can be obtained by appropriately controlling the kind or mixing amount of an additive, the molecular weight distribution of cellulose acylate, the kind of cellulose acylate, and the like. A film having various functional parts such as an optically anisotropic part, an anti-dazzling part, a gas barrier part, a moisture-resistant part, and the like in a piece of film of these is included.

[Phase Difference Film]

The cellulose acylate film of the present invention can be used as a phase difference film. The “phase difference film” is generally used in display devices such as liquid crystal display device, and the like, refers to an optical material having optical anisotropicity, and is synonymous with a phase difference plate, an optically compensatory film, an optically compensatory sheet, and the like. In the liquid display device, the phase difference film is used for the purpose of enhancing the contrast of a display screen or improving viewing angle characteristics or tint.

A phase difference film with the Re and Rth values freely controlled can be easily manufactured by using the transparent cellulose acylate film of the present invention.

The phase difference film may have an optically anisotropic layer containing at least one liquid crystalline compound in the cellulose acylate film of the present invention. The cellulose acylate film of the present invention can be used as a phase film having a desired phase difference value by stacking a plurality of cellulose acylate films of the present invention or stacking the cellulose acylate film of the present invention and a film other than the present invention to control Re or Rth appropriately. The stacking of films can be performed by using an adhesive or an adhesion bond.

In some cases, the cellulose acylate film of the present invention can be used as a support of a phase difference film, and as a phase difference film by providing an optically anisotropic layer including a liquid crystal, and the like thereon. The optically anisotropic layer applied to the phase difference film of the present invention may be formed of, for example, a composition containing liquid crystalline compounds, a cellulose acylate film having birefringence, and the cellulose acylate film of the present invention.

The liquid crystalline compounds are preferably a discotic liquid crystalline compounds or a rod-shaped liquid crystalline compound. Examples of the discotic liquid crystalline compounds include the compounds, and the like described in, for example, C. Destrade et al., Mol. Crysr. Liq. Cryst., Vol. 71, page 111 (1981); Kikan Kagaku Sosetsu, No. 22, Ekisho No Kagaku, chapter 5, chapter 10, section 2 (compiled by Nihon Kagaku Kai and published in 1994); B. Kohne et al., Angew. Chem. Soc. Chem. Comm., page 1794 (1985); and J. Zhang et al., J. Am. Chem. Soc., Vol. 116, page 2655 (1994).

In the optically anisotropic layer, the discotic liquid crystalline molecules are preferably fixed in an aligned state, and are most preferably fixed by a polymerization reaction. The polymerization of discotic liquid crystalline molecules is described in Japanese Patent Application Laid-Open No. Hei 8-27284. In order to fix the discotic liquid crystalline molecules by polymerization, it is necessary to bind a polymerizable group to a discotic core of the discotic liquid crystalline molecule as a substituent. However, when the polymerizable group is directly bound to the discotic core, it becomes difficult to maintain the orientation state for the polymerization reaction. Thus, a linking group is introduced between the discotic core and the polymerizable group. The discotic liquid crystal molecules having a polymerizable group are described in Japanese Patent Application Laid-Open No. 2001-4387.

[Functional Layer]

The cellulose acylate film of the present invention may further have functional layers. A functional film having a functional layer on the cellulose acylate film may have a single-layer or a stacked structure of two layers or more. Here, a polarizing plate of the present invention as described below preferably has a functional layer. However, the cellulose acylate film of the present invention may have a function layer, or other functional films may overlap each other when the cellulose film of the present invention is put into a polarizing plate.

Besides, the functional layers may be used as a film for enhancing brightness, or the cellulose acylate film having a forward scattering layer, an anti-glare layer (anti-dazzling layer), a gas barrier layer, a slip layer an antistatic layer, an undercoat layer and a protective layer may be used.

Each component or a forming method for forming a functional layer may be used from those described in well known literature, and the like.

[Polarizing Plate]

The polarizing plate of the present invention is a polarizing plate having protective films on both sides of a polarizer, wherein at least one of the protective films is the cellulose acylate film of the present invention. That is, it is preferable for the film of the present invention to be used as the protective film for a polarizing plate. As described above, the polarizing plate is formed by binding the protective film to at least one surface of the polarizer to achieve stacking. As a polarizer, those well known in the art can be used, and are obtained by treating a hydrophilic polymer film, for example, polyvinyl alcohol with a dichromic dye such as oxo and then stretching the hydrophilic polymer film. Binding the cellulose ester film to a polarizer is not particularly limited, but can be performed by an adhesive agent containing an aqueous solution of a water-soluble polymer. As the water soluble polymer adhesion bond, a completely saponified polyvinyl alcohol aqueous solution is preferably used.

In particular, a polarizing plate using the film of the present invention does not deteriorate easily and can maintain a stable performance for a long period of time under high temperature and high humidity conditions.

The polarizing plate of the present invention has the cellulose acylate film of the present invention. When the cellulose acylate film of the present invention is used as a protective film for a polarizing plate, it can be used preferably as a configuration of a protective film for a polarizing plate/a polarizer/a protective film for a polarizing plate/a liquid crystal cell/a protective film for a polarizing plate of the present invention/a polarizer/a protective film for a polarizing plate or as a configuration of a protective film for a polarizing plate/a polarizer/a protective film for a polarizing plate of the present invention/a liquid crystal cell/a protective film for a polarizing plate of the present invention/a polarizer/a protective film for a polarizing plate. In particular, a display device, which is further excellent in viewing angle and excellent in visibility with less coloring, can be provided by binding the polarizing plate to a liquid crystal cell, such as a TN type, a VA type, an OCT type, and the like.

[Liquid Crystal Display Device]

The liquid crystal display device of the present invention is a liquid crystal display device including a liquid crystal cell and two polarizing plates disposed on both sides thereof, and at least one of the polarizing plates is the polarizing plate of the present invention.

In the liquid crystal display device of the present invention, it is preferable that the liquid crystal cell is in an IPS mode, a VA mode, or a TN mode, and particularly preferably a VA mode cell in that the film of the present invention develops Re and Rth in the preferable range.

### EXAMPLES

Hereinafter, the present invention will be described in more detail with reference to Examples. The materials, reagents, amounts and ratios of substances, operations, and the like explained in Examples below may appropriately be modified without departing from the spirit of the present invention. Therefore, the scope of the present invention is not limited to the specific examples described below.

### Examples 1 to 18, Comparative Examples 1 to 22

### Formation of Cellulose Acylate Film

Cellulose acetate (A) and cellulose acylate (B), prepared with raw materials (pulp or linter) described in Table 1, were used. The cellulose acetate (A), cellulose acylate (B), plasticizer 1 and plasticizer 2 were added in an amount as described in Table 1 to a mixing tank, a solvent (a mixed solvent including 86.5 parts by mass of dichloromethanol and 13.5 parts by mass of methanol) was further added thereto, the mixture was stirred to dissolve the respective components, followed by filtration through a filter paper having an average pore diameter of 34 μm and a sintered metal filter having an average pore diameter of 10 μm to prepare a cellulose acylate dope. A film was formed by a solution casting method and then used in Examples 1 to 18 and Comparative Examples 1 to 22.

Meanwhile, the concentration of cellulose acylate in a dope was controlled to become 22% by mass. The dope was filtered through a filter paper (manufactured by Toyo Roshi Kaisha, Ltd., #63LB), further filtered through a sintered metal filter (manufactured by Nippon Seisen Co., Ltd., 06N, nominal pore size 10 μm), further filtered through a mesh filter, and then put into a stock tank.

(Solution Casting Method)

A film producing apparatus was used to form a film. The dope was stirred with an in-line mixer to obtain a casting dope.

A casting band was controlled such that the peripheral speed thereof in the casting band running direction could be kept almost constant within a range of from 20 m/min to 100 m/min. The temperature of the peripheral surface of the casting band was kept almost constant within a range of from 0° C. to 35° C.

Through the casting die, the casting dope was cast onto the peripheral surface of the casting band, thereby forming a casting film thereon. After the casting film obtained self-supporting, the casting band as a wet film was peeled off from the casting band by using a peeling roller.

In order to suppress peeling failure, the peeling speed (peeling roller draw) relative to the speed of the casting band was suitably controlled to fall within a range of from 100.1% to 110%. The wet film was conveyed via a transfer part to a tenter part and then to a drying chamber in order. In the transfer part, the tenter part and the drying chamber, dry air was applied to the wet film for drying the film in a predetermined manner. A film obtained by the drying treatment was transferred to a cooling chamber. Drying in each process was performed such that the temperature during the drying treatment could be kept constant at 75° C. or lower. In the cooling chamber, the film was cooled to 30° C. or lower.

Next, the film was processed for electrostatic discharging and knurling, and then conveyed to a winding chamber. In the winding chamber, the film was wound up while desired tension was given thereto by a press roller. The film thus produced by the film production apparatus had a width of from 1,300 mm to 2,500 mm and a thickness of 50 μm.

The following evaluation was made for the film sample thus manufactured. The evaluation results are shown in Table 1.

(Moist Heat Durability: Bleed Out)

The film sample was left to stand under an environment of 80° C. and relative humidity of 90% for 120 hours, and it was confirmed with eyes whether bleed out occurred to perform evaluation in accordance with the following criteria.

A: No bleed-out, transparent film

B: bleed-out generated, film whitened

(Humidity Dependence of Optical Properties)

Rth_{30%} was obtained at 550 nm after the film sample was left to stand under an environment of 25° C. and relative humidity of 30% for 3 hours and Rth_{80%} was obtained at 550 nm after the film sample was left to stand under an environment of 25° C. and relative humidity of 80% for 3 hours to calculate by using this formula (ΔRth=Rth_{30%}−Rth_{80%} (nm)).

(Haze)

Measurement of haze was conducted with a sample 40 mm×80 mm of the cellulose acylate film of the present invention at 25° C. and 60% RH in accordance with JIS K-6714 by using a haze meter “HGM-2DP” (manufactured by Suga Test Instruments Co., Ltd.).

B was given to the case where the haze measured value was more than 1.0%, A was given to the case where the measured haze value was 1.0% or less, and the results are shown in Table 1.

Meanwhile, for a sample with a haze value of B during forming the film, the moist heat durability test was not performed.

(Water Content)

The water content is measured by Karl-Fischer's method on a sample 7 mm×35 mm of the cellulose acylate film of the present invention using a moisture analyzer CA-03 and a sample drying device VA-05, (both of which manufactured by Mitsubishi Chemical Corp). The measured amount of water (g) is divided by the sample mass (g) to give a water content.

For several cellulose acylate film samples, glass transition temperature (Tg), moisture permeability, and elastic modulus were measured as an evaluation of other physical properties.

(Glass Transition Temperature)

A 5 mm×30 mm sample (not stretched) of the cellulose acylate film of the present invention is humidity controlled at 25° C. and 60% RH for at least 2 hours. Measurement is made with a dynamic viscoelasticity measuring device (Vibron: DVA-225 (manufactured by ITK Co., Ltd) at a distance between grips of 20 mm, at a heating rate of 2° C./min, at a measuring temperature range from 30° C. to 250° C., and at a frequency of 1 Hz. When the storage modulus is plotted on a logarithmic ordinate and temperature (° C.) is plotted on a linear abscissa, a straight line 1 and a straight line 2 showing a steep decrease in storage modulus observed at the phase transition from the solid region to the glass transition region are drawn in the solid region and the glass transition region, respectively. The intersection of the lines 1 and 2 indicates the temperature at which the storage modulus starts to decrease abruptly and the film starts to soften during heating, and at which the film begins to be transferred to the glass transition region. Therefore, this temperature is referred to as the glass transition temperature Tg (dynamic viscoelasticity).

(Moisture Permeability)

Measurement was performed under conditions of 60° C. and 95% RH in accordance with JIS Z-0208.

(Elastic Modulus of Film)

The stress was measured using a universal tensile tester “STM T50BP” manufactured by Toyo Baldwin Co., Ltd. to determine the elastic modulus when the sample is stretched by 0.5% under the conditions of 255° C., 60% RH, and stretching rate of 10%/min.

TABLE 1

| | Cellulose acylate (A) | | | Cellulose acylate (B) | | | | | | |
|---|---|---|---|---|---|---|---|---|---|---|
| | | Substitution | Total | | Substitution | Substitution | Substitution | Total | Cellulose acylate (A)/(B) | |
| | Raw | Degree with | Substitution | Raw | Degree with | Degree with | Degree with | Substitution | Mixed mass ratio | |
| | material | acetyl group | Degree | material | acetyl group | propionyl group | butyryl group | Degree | (A) | (B) |
| C. 1 | Pulp | 2.85 | 2.85 | | | | | | 100 | 0 |
| C. 2 | Linter | 2.85 | 2.85 | | | | | | 100 | 0 |
| E. 1 | Pulp | 2.85 | 2.85 | Pulp | 2.02 | 0.00 | 0.70 | 2.72 | 90 | 10 |
| E. 2 | Linter | 2.85 | 2.85 | Pulp | 2.02 | 0.00 | 0.70 | 2.72 | 90 | 10 |
| C. 3 | Pulp | 2.94 | 2.94 | | | | | | 100 | 0 |
| C. 4 | Linter | 2.94 | 2.94 | | | | | | 100 | 0 |
| C. 5 | Linter | 2.94 | 2.94 | | | | | | 100 | 0 |
| C. 6 | Linter | 2.94 | 2.94 | | | | | | 100 | 0 |
| C. 7 | Linter | 2.94 | 2.94 | | | | | | 100 | 0 |
| C. 8 | Linter | 2.94 | 2.94 | | | | | | 100 | 0 |
| C. 9 | Linter | 2.94 | 2.94 | | | | | | 100 | 0 |
| C. 10 | Linter | 2.94 | 2.94 | Pulp | 2.02 | 0.00 | 0.70 | 2.72 | 90 | 10 |
| E. 3 | Linter | 2.94 | 2.94 | Pulp | 2.02 | 0.00 | 0.70 | 2.72 | 90 | 10 |
| C. 11 | Linter | 2.94 | 2.94 | Pulp | 2.02 | 0.00 | 0.70 | 2.72 | 90 | 10 |
| C. 12 | Linter | 2.94 | 2.94 | Pulp | 2.02 | 0.00 | 0.70 | 2.72 | 90 | 10 |
| E. 4 | Linter | 2.94 | 2.94 | Pulp | 2.02 | 0.00 | 0.70 | 2.72 | 90 | 10 |
| E. 5 | Linter | 2.94 | 2.94 | Pulp | 2.02 | 0.00 | 0.70 | 2.72 | 90 | 10 |
| E. 6 | Linter | 2.94 | 2.94 | Pulp | 2.02 | 0.00 | 0.70 | 2.72 | 90 | 10 |
| E. 7 | Linter | 2.94 | 2.94 | Pulp | 2.02 | 0.00 | 0.70 | 2.72 | 90 | 10 |
| E. 8 | Linter | 2.94 | 2.94 | Pulp | 2.02 | 0.00 | 0.70 | 2.72 | 90 | 10 |
| E. 9 | Linter | 2.94 | 2.94 | Pulp | 1.00 | 0.00 | 1.66 | 2.66 | 90 | 10 |
| E. 10 | Linter | 2.94 | 2.94 | Pulp | 2.11 | 0.63 | 0.00 | 2.74 | 90 | 10 |
| C. 13 | Linter | 2.94 | 2.94 | Pulp | 2.51 | 0.00 | 0.20 | 2.71 | 90 | 10 |
| C. 14 | Linter | 2.94 | 2.94 | Pulp | 0.60 | 0.00 | 2.01 | 2.61 | 90 | 10 |
| C. 15 | Linter | 2.94 | 2.94 | Pulp | 0.18 | 2.47 | 0.00 | 2.65 | 90 | 10 |
| C. 16 | Linter | 2.94 | 2.94 | Pulp | 0.23 | 0.00 | 2.51 | 2.74 | 90 | 10 |
| C. 17 | Pulp | 2.94 | 2.94 | | | | | | 100 | 0 |
| C. 18 | Linter | 2.94 | 2.94 | | | | | | 100 | 0 |
| C. 19 | Linter | 2.94 | 2.94 | Pulp | 2.51 | 0.00 | 0.20 | 2.71 | 90 | 10 |
| E. 14 | Pulp | 2.94 | 2.94 | Pulp | 2.02 | 0.00 | 0.70 | 2.72 | 80 | 20 |
| E. 15 | Linter | 2.94 | 2.94 | Pulp | 2.02 | 0.00 | 0.70 | 2.72 | 80 | 20 |
| E. 16 | Linter | 2.94 | 2.94 | Pulp | 2.02 | 0.00 | 0.70 | 2.72 | 80 | 20 |
| E. 17 | Linter | 2.94 | 2.94 | Pulp | 2.02 | 0.00 | 0.70 | 2.72 | 60 | 40 |
| E. 18 | Linter | 2.94 | 2.94 | Pulp | 2.02 | 0.00 | 0.70 | 2.72 | 50 | 50 |
| C. 20 | Linter | 2.94 | 2.94 | Pulp | 2.02 | 0.00 | 0.70 | 2.72 | 30 | 70 |
| C. 21 | | | | Pulp | 2.02 | 0.00 | 0.70 | 2.72 | 0 | 100 |
| C. 22 | | | | Pulp | 0.60 | 0.00 | 2.20 | 2.80 | 0 | 100 |

| | Degree of substitution of cellulose acylate after mixing | | | | | | | | |
|---|---|---|---|---|---|---|---|---|---|
| | Substitution | Substitution | Substitution | | | | | | |
| | Degree with | Degree with | Degree with | Acetyl group have | Total | | | | |
| | acetyl | propionyl | butyryl | 3 or more in | Substitution | Plasticizer | Amount of | Plasticizer | Amount of |
| | group | group | group | carbon number | Degree | 1 | plasticizer 1 | 2 | plasticizer 2 |
| C. 1 | 2.85 | 0.00 | 0.00 | 0.00 | 2.85 | P-1 | 45 | | |
| C. 2 | 2.85 | 0.00 | 0.00 | 0.00 | 2.85 | P-1 | 45 | | |
| E. 1 | 2.77 | 0.00 | 0.07 | 0.07 | 2.84 | P-1 | 45 | | |
| E. 2 | 2.77 | 0.00 | 0.07 | 0.07 | 2.84 | P-1 | 45 | | |
| C. 3 | 2.94 | 0.00 | 0.00 | 0.00 | 2.94 | P-1 | 45 | | |
| C. 4 | 2.94 | 0.00 | 0.00 | 0.00 | 2.94 | P-1 | 45 | | |
| C. 5 | 2.94 | 0.00 | 0.00 | 0.00 | 2.94 | Sugar ester 1 | 40 | | |
| C. 6 | 2.94 | 0.00 | 0.00 | 0.00 | 2.94 | Sugar ester 2 | 40 | | |
| C. 7 | 2.94 | 0.00 | 0.00 | 0.00 | 2.94 | Polyhydric | 40 | | |
| | | | | | | alcohol | | | |
| C. 8 | 2.94 | 0.00 | 0.00 | 0.00 | 2.94 | Citric acid | 40 | | |
| | | | | | | ester | | | |
| C. 9 | 2.94 | 0.00 | 0.00 | 0.00 | 2.94 | Phthalic acid | 40 | | |
| | | | | | | ester | | | |
| C. 10 | 2.85 | 0.00 | 0.07 | 0.07 | 2.92 | P-1 | 25 | | |
| E. 3 | 2.85 | 0.00 | 0.07 | 0.07 | 2.92 | P-1 | 45 | | |
| C. 11 | 2.85 | 0.00 | 0.07 | 0.07 | 2.92 | P-1 | 70 | | |
| C. 12 | 2.85 | 0.00 | 0.07 | 0.07 | 2.92 | P-1 | 80 | | |
| E. 4 | 2.85 | 0.00 | 0.07 | 0.07 | 2.92 | Sugar ester 1 | 40 | | |
| E. 5 | 2.85 | 0.00 | 0.07 | 0.07 | 2.92 | Sugar ester 2 | 40 | | |
| E. 6 | 2.85 | 0.00 | 0.07 | 0.07 | 2.92 | Polyhydric | 40 | | |
| | | | | | | alcohol | | | |
| E. 7 | 2.85 | 0.00 | 0.07 | 0.07 | 2.92 | Citric acid | 40 | | |
| | | | | | | ester | | | |
| E. 8 | 2.85 | 0.00 | 0.07 | 0.07 | 2.92 | Phthalic acid | 40 | | |
| | | | | | | ester | | | |
| E. 9 | 2.75 | 0.00 | 0.17 | 0.17 | 2.91 | P-1 | 45 | | |
| E. 10 | 2.86 | 0.06 | 0.00 | 0.06 | 2.92 | P-1 | 45 | | |
| C. 13 | 2.90 | 0.00 | 0.02 | 0.02 | 2.92 | P-1 | 45 | | |
| C. 14 | 2.71 | 0.00 | 0.20 | 0.20 | 2.91 | P-1 | 45 | | |
| C. 15 | 2.66 | 0.25 | 0.00 | 0.25 | 2.91 | P-1 | 45 | | |
| C. 16 | 2.67 | 0.00 | 0.25 | 0.25 | 2.92 | P-1 | 45 | | |
| C. 17 | 2.94 | 0.00 | 0.00 | 0.00 | 2.94 | P-1 | 53 | P-23 | 6 |
| C. 18 | 2.94 | 0.00 | 0.00 | 0.00 | 2.94 | P-1 | 53 | P-23 | 6 |
| C. 19 | 2.90 | 0.00 | 0.02 | 0.02 | 2.92 | P-1 | 53 | P-23 | 6 |
| E. 14 | 2.76 | 0.00 | 0.14 | 0.14 | 2.90 | P-1 | 53 | P-23 | 6 |
| E. 15 | 2.76 | 0.00 | 0.14 | 0.14 | 2.90 | P-1 | 53 | Pyrimidine | 6 |
| | | | | | | | | compound 1 | |
| E. 16 | 2.76 | 0.00 | 0.14 | 0.14 | 2.90 | P-1 | 53 | P-23 | 6 |
| E. 17 | 2.57 | 0.00 | 0.28 | 0.28 | 2.85 | P-1 | 53 | P-23 | 6 |
| E. 18 | 2.48 | 0.00 | 0.35 | 0.35 | 2.83 | P-1 | 53 | P-23 | 6 |
| C. 20 | 2.30 | 0.00 | 0.49 | 0.49 | 2.79 | P-1 | 53 | P-23 | 6 |
| C. 21 | 2.02 | 0.00 | 0.70 | 0.70 | 2.72 | P-1 | 53 | P-23 | 6 |
| C. 22 | 0.60 | 0.00 | 2.20 | 2.20 | 2.80 | P-1 | 53 | P-23 | 6 |

| | | | | | | Tg Tan δ Peak | | |
|---|---|---|---|---|---|---|---|---|
| | | moist heat | | Temperature dependence | | temperature | Moisture | Elastic |
| | | durability | water | of optical properties | Roll winding | by Vibron | permeability | modulus |
| | Haze (%) | (bleed out) | content | ΔRth (nm) | length | measurement | (g/m²/day) | (GPa) |
| C. 1 | O(0.24) | B | 2.1% | 5.9 | 3900 m | | | |
| C. 2 | O(0.24) | B | 2.1% | 6.0 | 3900 m | | | |
| E. 1 | O(0.21) | A | 1.9% | 4.5 | 3900 m | | | |
| E. 2 | O(0.23) | A | 1.9% | 4.2 | 3900 m | | | |
| C. 3 | O(0.25) | B | 1.9% | 5.5 | 3900 m | | | |
| C. 4 | O(0.34) | B | 1.9% | 5.4 | 3900 m | 160.2 | 1974 | 1.9 |
| C. 5 | O(0.34) | B | 2.1% | 6.0 | 3900 m | | | |
| C. 6 | O(0.30) | B | 2.1% | 6.5 | 3900 m | | | |
| C. 7 | O(0.25) | B | 1.9% | 6.0 | 3900 m | | | |
| C. 8 | O(0.31) | B | 1.9% | 5.5 | 3900 m | | | |
| C. 9 | O(0.28) | B | 2.0% | 5.4 | 3900 m | | | |
| C. 10 | O(0.30) | A | 1.8% | 10.5 | 5200 m | | | |
| E. 3 | O(0.33) | A | 1.8% | 4.0 | 5200 m | 159.1 | 2136 | 1.6 |
| C. 11 | X(3.5) | | 1.8% | Not measured due to | 5200 m | | | |
| | | | | generation of break-down | | | | |
| C. 12 | X(10.3) | | 1.8% | Not measured due to | 5200 m | | | |
| | | | | generation of break-down | | | | |
| E. 4 | O(0.27) | A | 2.0% | 4.7 | 5200 m | | | |
| E. 5 | O(0.22) | A | 2.0% | 4.8 | 5200 m | | | |
| E. 6 | O(0.26) | A | 1.8% | 5.3 | 5200 m | | | |
| E. 7 | O(0.32) | A | 1.9% | 4.5 | 5200 m | | | |
| E. 8 | O(0.19) | A | 1.9% | 4.4 | 5200 m | | | |
| E. 9 | O(0.29) | A | 1.8% | 3.8 | 5200 m | | | |
| E. 10 | O(0.20) | A | 1.8% | 4.4 | 5200 m | | | |
| C. 13 | O(0.29) | B | 2.0% | 4.5 | 5200 m | | | |
| C. 14 | X(5.31) | | 1.7% | 3.5 | 5200 m | | | |
| C. 15 | X(3.47) | | 1.8% | 3.7 | 5200 m | | | |
| C. 16 | X(4.50) | | 1.8% | 3.5 | 5200 m | | | |
| C. 17 | O(0.16) | B | 1.8% | 2.1 | 3900 m | 168.6 | 2183 | 1.5 |
| C. 18 | O(0.12) | B | 1.8% | 2.2 | 3900 m | | | |
| C. 19 | O(0.19) | B | 1.7% | 3.5 | 5200 m | | | |
| E. 14 | O(0.15) | A | 1.7% | 1.5 | 5200 m | 162.9 | 2027 | 1.3 |
| E. 15 | O(0.12) | A | 1.7% | 0.1 | 5200 m | 160.5 | 2013 | 1.3 |
| E. 16 | O(0.12) | A | 1.7% | 1.3 | 7800 m | 163.5 | 2187 | 1.3 |
| E. 17 | O(0.14) | A | 1.7% | 0.9 | 5200 m | 156.1 | 2382 | 1.1 |
| E. 18 | O(0.17) | A | 1.6% | 0.6 | 5200 m | 150.1 | 2451 | 1.0 |
| C. 20 | X(1.56) | | 1.5% | 0.4 | 5200 m | | | 0.7 |
| C. 21 | X(3.06) | | 1.5% | 0.3 | 5200 m | | | 0.6 |
| C. 22 | X(3.65) | | 1.4% | 0.1 | 5200 m | | | 0.4 |

In Table 1, the amounts of plasticizer 1 and plasticizer 2 to be added are represented by a ratio by mass based on total amount of cellulose acetate (A) and cellulose acylate (B), respectively.

Meanwhile, polyester-based additives P-1 to P-23 described in Table 1 were obtained from mixtures including aromatic dicarboxylic acid, aliphatic dicarboxylic acid, and aliphatic diol having an average carbon number of 2.0 to 3.0, and are polycondensate esters of which both terminals are a hydroxyl group or a monocarboxylic acid ester derivative.

TABLE 2

| | Dicarboxylic acid *¹⁾ | | | Diol | | | | |
|---|---|---|---|---|---|---|---|---|
| | Aromatic | Aliphatic | Ratio of | | Ratio | Average carbon | | |
| | Dicarboxylic | Dicarboxylic | dicarboxylic | Aliphatic | of diol | number of | | Number average |
| Additive | acid | acid | acids (mol %) | diol | (mol %) | aliphatic diol | Terminal | molecular weight |
| P-1 | — | AA | 100 | Ethylene glycol | 100 | 2.0 | Acetyl ester residue | 1000 |
| P-2 | — | AA/SA | 75/25 | Ethylene glycol | 100 | 2.0 | Acetyl ester residue | 1000 |
| P-3 | — | AA/SA | 50/50 | Ethylene glycol | 100 | 2.0 | Acetyl ester residue | 1000 |
| P-4 | — | AA/SA | 25/75 | Ethylene glycol | 100 | 2.0 | Acetyl ester residue | 1000 |
| P-5 | — | SA | 100 | Ethylene glycol | 100 | 2.0 | Acetyl ester residue | 1000 |
| P-6 | — | AA | 100 | Ethylene glycol/ | 25/75 | 2.25 | Acetyl ester residue | 1000 |
| | | | | 1,2-Propanediol | | | | |
| P-7 | — | AA | 100 | Ethylene glycol/ | 50/50 | 2.5 | Acetyl ester residue | 1000 |
| | | | | 1,2-Propanediol | | | | |
| P-8 | — | AA | 100 | Ethylene glycol/ | 75/25 | 2.75 | Acetyl ester residue | 1000 |
| | | | | 1,2-Propanediol | | | | |
| P-9 | — | AA | 100 | 1,2-Propanediol | 100 | 3.0 | Acetyl ester residue | 1000 |
| P-10 | — | AA | 100 | Ethylene glycol | 100 | 2.0 | Hydroxyl residue | 1000 |
| P-11 | — | AA/SA | 50/50 | Ethylene glycol | 100 | 2.0 | Hydroxyl residue | 1000 |
| P-12 | PA | AA | 10/90 | Ethylene glycol | 100 | 2.0 | Acetyl ester residue | 1000 |
| P-13 | PA | AA | 25/75 | Ethylene glycol | 100 | 2.0 | Acetyl ester residue | 1000 |
| P-14 | PA | AA | 50/50 | Ethylene glycol | 100 | 2.0 | Acetyl ester residue | 1000 |
| P-15 | TPA | AA | 50/50 | Ethylene glycol | 100 | 2.0 | Acetyl ester residue | 1000 |
| P-16 | TPA | SA | 50/50 | Ethylene glycol | 100 | 2.0 | Acetyl ester residue | 1000 |
| P-17 | TPA | AA/SA | 10/30/60 | Ethylene glycol | 100 | 2.0 | Acetyl ester residue | 1000 |
| P-18 | TPA | AA/SA | 10/30/60 | Ethylene glycol/ | 50/50 | 2.5 | Acetyl ester residue | 1000 |
| | | | | 1,2-Propanediol | | | | |
| P-19 | TPA | AA/SA | 10/30/60 | 1,2-Propanediol | 100 | 3.0 | Acetyl ester residue | 1000 |
| P-20 | TPA/PA | AA/SA | 45/5/25/25 | Ethylene glycol | 100 | 2.0 | Acetyl ester residue | 750 |
| P-21 | TPA/PA | AA | 45/5/50 | Ethylene glycol | 100 | 2.0 | Acetyl ester residue | 800 |
| P-22 | TPA | SA | 55/45 | Ethylene glycol/ | 50/50 | 2.5 | Acetyl ester residue | 750 |
| | | | | 1,2-Propanediol | | | | |
| P-23 | TPA | AA | 50/50 | Ethylene glycol/ | 50/50 | 2.5 | Acetyl ester residue | 750 |
| | | | | 1,2-Propanediol | | | | |

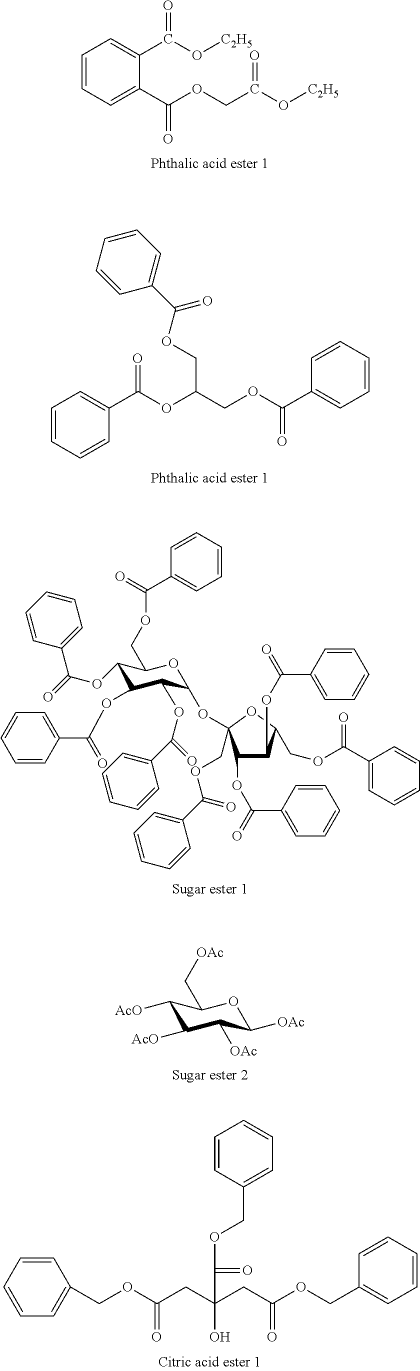

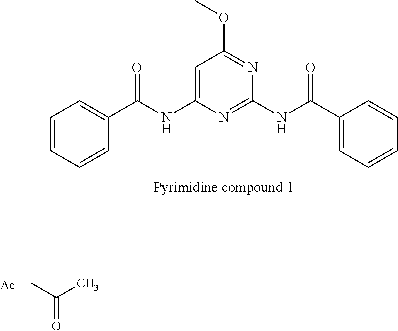

### Examples 19 to 28

A film was prepared in the same manner as in Example 15, except that [Plasticizer 1] was changed from P-1 to P-2 to P-11, respectively, and evaluation thereof was performed. All of the results of haze and moist heat durability were A as in Example 15.

### Examples 29 to 38

A film was prepared in the same manner as in Example 16, except that [Plasticizer 2] was changed from P-23 to P-12 to P-22, respectively, and evaluation thereof was performed. All of the results of haze and moist heat durability were A as in Example 15.

### Comparative Examples 23 to 32

A film was prepared in the same manner as in Comparative Example 19, except that [Plasticizer 1] was changed from P-1 to P-2 to P-11, respectively, and evaluation thereof was performed. All of the results of moist heat durability were B as in Comparative Example 19.

### Comparative Examples 33 to 43

A film was prepared in the same manner as in Comparative Example 19, except that [Plasticizer 2] was changed from P-23 to P-12 to P-22, respectively, and evaluation thereof was performed. All of the results of moist heat durability were B as in Comparative Example 19.

While the present invention has been shown and described with reference to certain exemplary embodiments thereof, it will be understood by those skilled in the art that various changes modifications may be made therein without departing from the spirit and scope of the present invention as defined by the appended claims.

What is claimed is:

1. A cellulose acylate film, comprising:
a cellulose acylate mixture; and
a plasticizer,
wherein
the cellulose acylate mixture contains:
a cellulose acetate (A) having a degree of substitution with acetyl group of 2.7 to 2.95; and
a cellulose acylate (B) having a total degree of substitution with acyl group of 2.0 to 2.9 and a degree of substation with acyl group having 3 to 6 carbon atoms of 0.05 to 0.40,
a mixing ratio of the cellulose acetate (A) to the cellulose acylate (B) is 90/10 to 40/60 by mass,
the cellulose acylate mixture has a total degree of substitution with acyl group of 2.6 to 2.95, a degree of substitution with acetyl group of 2.2 to 2.9, and a degree of substitution with acyl group having 3 to 6 carbon atoms of 0.05 to 0.40, and
an amount of the plasicizer is 30% to 60% by mass based on the cellulose acylate mixture.

2. The cellulose acylate film according to claim 1,
wherein the plasticizer contains a mixture comprising:
at least one of aromatic dicarboxylic acid and aliphatic dicarboxylic acid; and
an aliphatic diol having an average carbon number of 2.0 to 3.0, and the plasticizer is a polycondensate ester of which both terminals are a hydroxyl group.

3. The cellulose acylate film according to claim 1,
wherein the plasticizer contains a mixture comprising:
at least one of aromatic dicarboxylic acid and aliphatic dicarboxylic acid;
an aliphatic diol having an average carbon number of 2.0 to 3.0; and
a monocarboxylic acid, and
the plasticizer is a polycondensate ester of which both terminals include a monocarboxylic acid ester derivative.

4. The cellulose acylate film according to claim 2,
wherein the plasticizer contains a nitrogen containing aromatic compound.

5. The cellulose acylate film according to claim 3,
wherein the plasticizer contains a nitrogen containing aromatic compound.

6. The cellulose acylate film according to claim 4,
wherein the nitrogen containing aromatic compound is contained in an amount of 20% by mass or less based on the cellulose acylate mixture.

7. The cellulose acylate film according to claim 5,
wherein the nitrogen containing aromatic compound is contained in an amount of 20% by mass or less based on the cellulose acylate mixture.

8. The cellulose acylate film of according to claim 1,
wherein the acyl group having 3 to 6 carbon atoms is at least one selected from a propionyl group and a butyryl group.

9. The cellulose acylate film of according to claim 1,
wherein the mixing ratio of the cellulose acetate (A) to the cellulose acylate (B) is 90/10 to 50/50 by mass.

10. A polarizing plate, comprising:
a polarizing film; and
at least one protective film,
wherein the at least one protective film is the cellulose acylate film according to claim 1.

11. A liquid crystal display device comprising the cellulose acylate film according to claim 1.

12. A liquid crystal display device comprising the polarizing plate according to claim 10.
